(19) United States
(12) Patent Application Publication
(10) Pub. No.: US 2026/0304494 A1
(43) Pub. Date: Oct. 1, 2026

(54) ADAPTABLE PRACH CONFIGURATION IN WIRELESS SYSTEMS

(71) Applicant: Samsung Electronics Co., Ltd., Suwon-si (KR)

(72) Inventors: Emad Nader Farag, Flanders, NJ (US); Aristides Papasakellariou, Houston, TX (US); Hongbo Si, Plano, TX (US); Ebrahim MolavianJazi, San Jose, CA (US); Marian Rudolf, Longueuil (CA)

(21) Appl. No.: 19/562,623

(22) Filed: Mar. 10, 2026

Related U.S. Application Data
(60) Provisional application No. 63/781,756, filed on Apr. 1, 2025.

(51) Int. Cl. H04W 74/0833; H04B 7/06; H04W 72/23

(52) U.S. Cl. CPC H04W 74/0833; H04B 7/0626; H04W 72/23

(57) ABSTRACT

Apparatuses and methods for adaptable physical random access channel (PRACH) in a wireless communication system. A method of operating a user equipment (UE) includes receiving configuration information for N PRACH configurations, 0, 1, . . . , N−1 associated with N sets of PRACH occasions (ROs), 0, 1, . . . , N−1, respectively, transmitting a first PRACH preamble using a first PRACH configuration from the N PRACH configurations, and receiving a channel or signal indicating a second PRACH configuration from the N PRACH configurations. The method further includes determining a second PRACH preamble based on the second PRACH configuration and transmitting the second PRACH preamble.

### CROSS-REFERENCE TO RELATED AND CLAIM OF PRIORITY

The present application claims priority under 35 U.S.C. § 119 (e) to U.S. Provisional Patent Application No. 63/781,756 filed on Apr. 1, 2025, which is hereby incorporated by reference in its entirety.

### TECHNICAL FIELD

The present disclosure relates generally to wireless communication systems and, more specifically, the present disclosure is related to an adaptable physical random access channel (PRACH) in a wireless communication system.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to an adaptable PRACH in a wireless communication system.

In one embodiment, a user equipment (UE) is provided. The UE including a transceiver configured to receive configuration information for N physical random access channel (PRACH) configurations, 0, 1, . . . , N−1 associated with N sets of PRACH occasions (ROs), 0, 1, . . . , N−1, respectively, transmit a first PRACH preamble using a first PRACH configuration from the N PRACH configurations, and receive a channel or signal indicating a second PRACH configuration from the N PRACH configurations. The UE further includes a processor operably coupled to the transceiver. The processor is configured to determine a second PRACH preamble based on the second PRACH configuration. The transceiver is further configured to transmit the second PRACH preamble.

In another embodiment, a base station (BS) is provided. The BS includes a transceiver configured to transmit configuration information for N PRACH configurations, 0, 1, . . . , N−1, associated with N sets of ROs, 0, 1, . . . , N−1, respectively and receive a first PRACH preamble using a first PRACH configuration from the N PRACH configurations. The BS further includes a processor operably coupled to the transceiver. The processor is configured to determine a second PRACH configuration from the N PRACH configurations. The transceiver is further configured to transmit a channel or signal indicating a second PRACH configuration and receive a second PRACH preamble based on the second PRACH configuration.

In yet another embodiment, a method of operating a UE is provided. The method includes receiving configuration information for N PRACH configurations, 0, 1, . . . , N−1 associated with N sets of ROs, 0, 1, . . . , N−1, respectively, transmitting a first PRACH preamble using a first PRACH configuration from the N PRACH configurations, and receiving a channel or signal indicating a second PRACH configuration from the N PRACH configurations. The method further includes determining a second PRACH preamble based on the second PRACH configuration and transmitting the second PRACH preamble.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIG. 7 illustrates an example synchronization signal block (SSB) utilized in a cell search procedure according to embodiments of the present disclosure;

FIGS. 8 and 9 illustrate example SSB patterns according to embodiments of the present disclosure;

FIG. 10 illustrates an example of PRACH occurrences (ROs) according to embodiments of the present disclosure;

FIG. 11 illustrates example parameters for PRACH configuration according to embodiments of the present disclosure;

FIG. 12 illustrates examples of subframe or 60 kHz slot utilization for PRACH based on the sub-carrier spacing of the PRACH according to embodiments of the present disclosure;

FIG. 13 illustrates examples of Type-1 random access procedures according to embodiments of the present disclosure;

FIG. 14 illustrates examples of Type-2 random access procedures according to embodiments of the present disclosure;

FIG. 15 illustrates an example of the traffic activity being transmitted over a network in a wireless communication system according to embodiments of the present disclosure;

FIG. 16 illustrates an example of time domain parameters for PRACH configuration according to embodiments of the present disclosure;

FIG. 17 illustrates an example of an RO according to embodiments of the present disclosure;

FIGS. 18A and 18B illustrate example methods that are performed in a wireless communication system according to embodiments of the present disclosure;

FIGS. 19A-22 illustrate timing examples for applying a new PRACH configuration upon indication according to embodiments of the present disclosure;

FIG. 23 illustrates examples of a first and second set of ROs according to embodiments of the present disclosure;

FIG. 24 illustrates alternative examples of a first and second set of ROs according to embodiments of the present disclosure;

FIGS. 25A-27 illustrate examples of channel/signal indication for activating a set of ROs according to embodiments of the present disclosure;

FIG. 28 illustrates an example of a channel/signal for requesting or activating a set of ROs according to embodiments of the present disclosure;

FIG. 29 illustrates an example of PRACH transmission in the ROs performed by the UE according to embodiments of the present disclosure;

FIGS. 30 and 31 illustrate examples of a first and second set of ROs according to embodiments of the present disclosure;

FIGS. 32-34B illustrate examples of a channel/signal for requesting or activating a set of ROs according to embodiments of the present disclosure;

FIG. 35 illustrates an example of a first and second PRACH configuration according to embodiments of the present disclosure; and

FIG. 36 illustrates an example method performed by a UE in a wireless communication system according to embodiments of the present disclosure.

### DETAILED DESCRIPTION

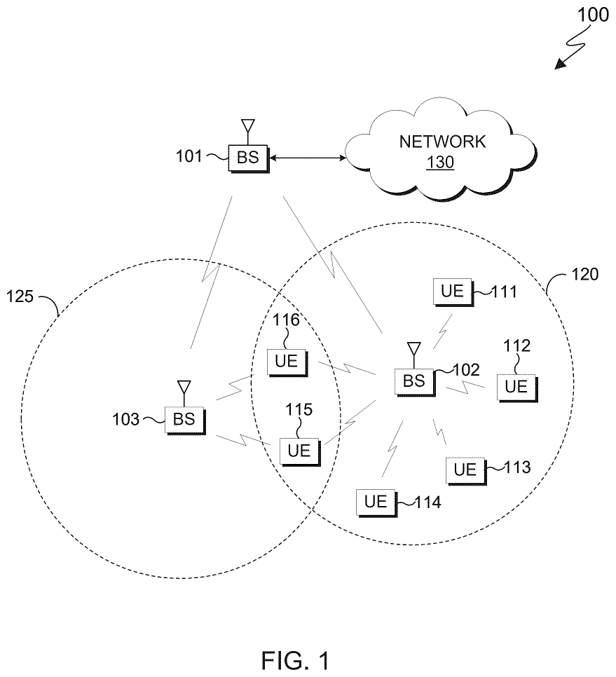

FIGS. 1-36 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.5.0, “NR; Physical channels and modulation” (herein, “REF 1”); 3GPP TS 38.212 v18.5.0, “NR; Multiplexing and Channel coding” (herein, “REF 2”); 3GPP TS 38.213 v18.5.0, “NR; Physical Layer Procedures for Control” (herein, “REF 3”); 3GPP TS 38.214 v18.5.0, “NR; Physical Layer Procedures for Data” (herein, “REF 4”); 3GPP TS 38.321 v18.4.0, “NR; Medium Access Control (MAC) protocol specification” (herein, “REF 5”); and 3GPP TS 38.331 v18.4.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing an adaptable PRACH. In certain embodiments, one or more of the BSs 101-103 include circuitry, programing, or a combination thereof to support an adaptable PRACH.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

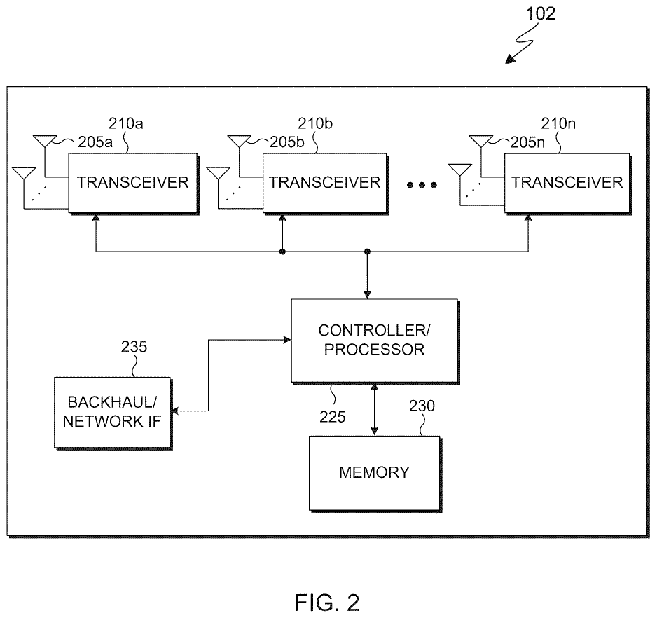

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting an adaptable PRACH. Any of a wide variety of other functions could be supported in the BS 102 by the controller/processor 225.

The controller/processor 225 is also capable of executing programs and other processes resident in the memory 230, such as processes to support an adaptable PRACH. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

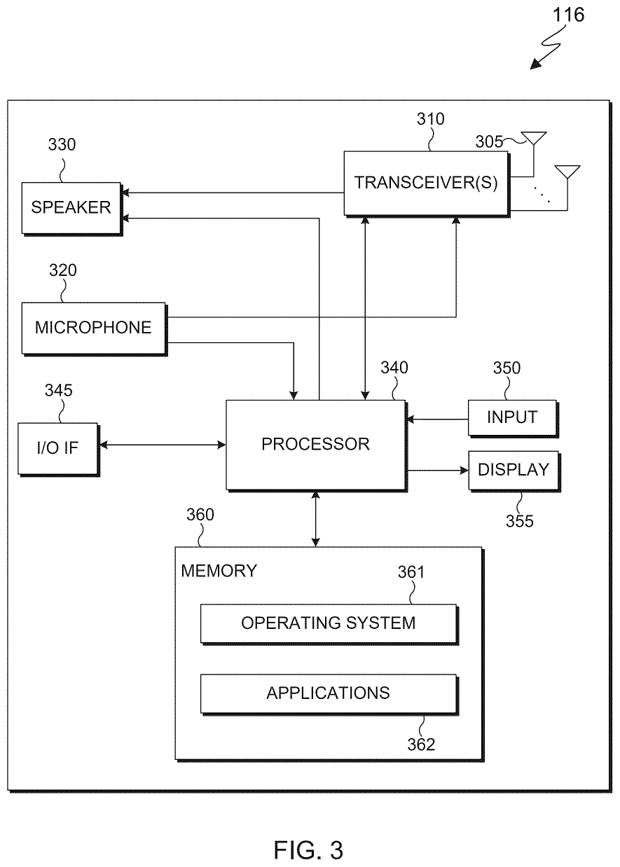

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing an adaptable PRACH as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

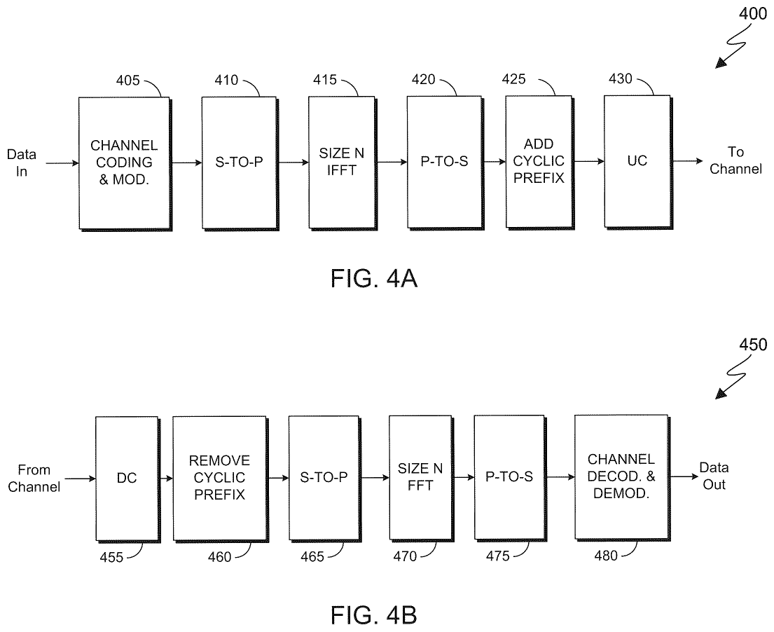

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting an adaptable PRACH as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam can be determined by any of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or the TCI state or the spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

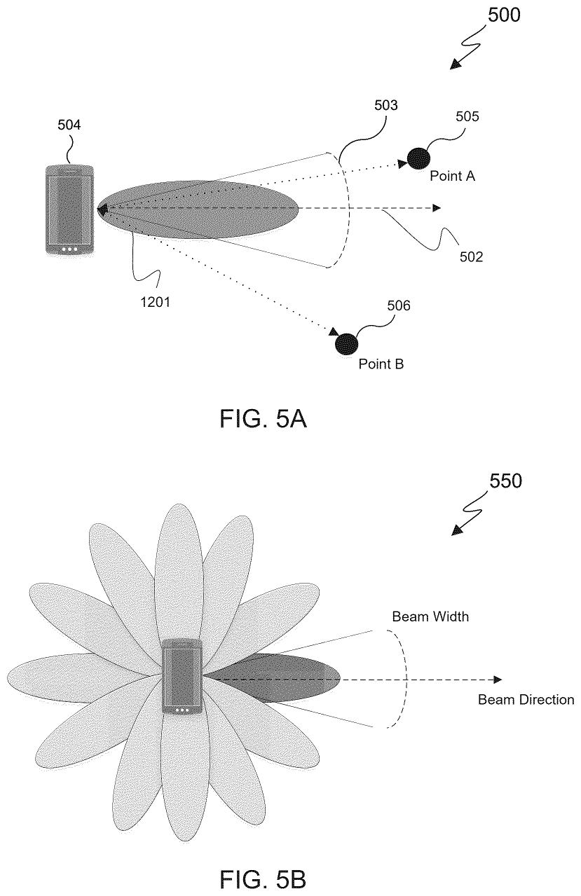

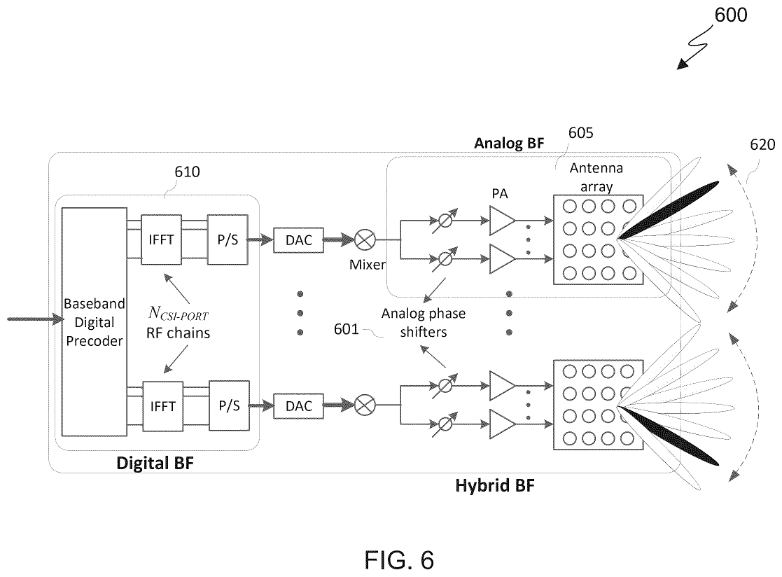

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art, that beams can be 3D, where the beams can be transmitted to or received from any direction in space.

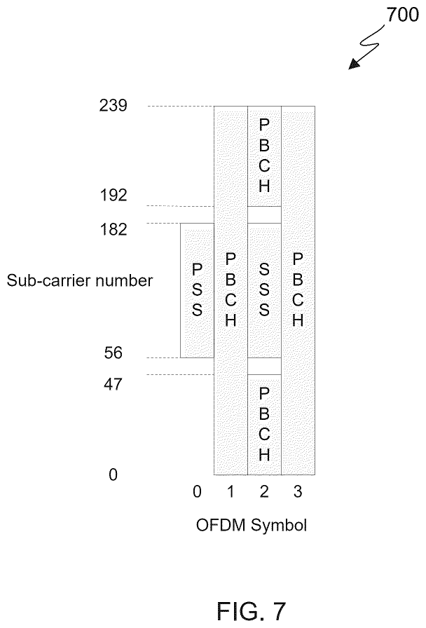

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Rel-17 introduced the unified TCI framework, where a unified or master or main or indicated TCI state is signaled to the UE. The unified or master or main or indicated TCI state can be one of:
In the case of joint TCI state indication, wherein a same beam is used for DL and UL channels, a joint TCI state that can be used at least for UE-dedicated DL channels and UE-dedicated UL channels.
In the case of separate TCI state indication, wherein different beams are used for DL and UL channels, a DL TCI state that can be used at least for UE-dedicated DL channels.
In the case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [REF 4-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as an SSB.

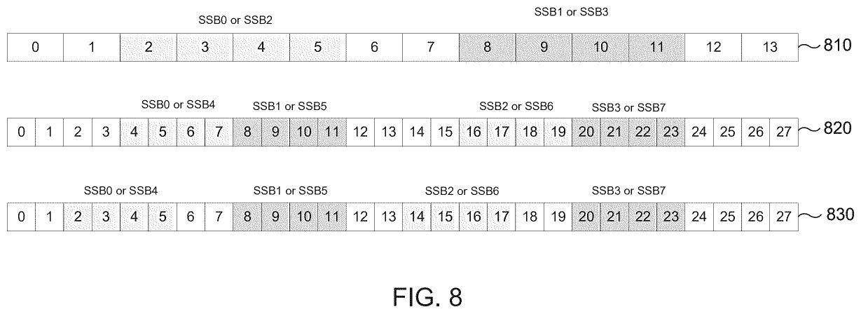

FIG. 7 illustrates an example SSB 700 utilized in a cell search procedure according to embodiments of the present disclosure. For example, SSB 700 can be transmitted by BS 102 or received by any one of the UEs 111-116 of FIG. 1. This example is for illustration only and other embodiments can be used without departing from the scope of the present disclosure.

As illustrated in FIG. 7, SSB 700 consists of 4 consecutive symbols, and 20 resource blocks (RBs) (240 subcarriers). Further, the structure of SSB 700 is shown. The first symbol includes the primary synchronization signal (PSS) mapped to the 12 middle RBs of the SSB. The 4 outer RBs of the first symbol of the SSB at each edge are empty. The third symbol includes the secondary synchronization signal (SSS) mapped to the 12 middle RBs of the SSB. The second and fourth symbols as well as the 4 outer RBs of the SSBs of the third symbol are mapped to PBCH. For a 3 MHz channel bandwidth, the PBCH is further punctured equally from both edges to span 144 sub-carriers (i.e., 12 RBs).

The RBs allocated to PBCH include PBCH DM-RS, which is mapped to 3 out of 12 resource elements (REs) of each RB. The starting position of the REs used for PBCH DM-RS is determined based on the cell ID. PBCH uses Polar coding and QPSK modulation. The same sub-carrier spacing is applied to PSS, SSS and PBCH. The SSB is transmitted periodically with a period that can be one of {5, 10, 20, 40, 80, 160} ms, with 20 ms being the default period used by the UE before accessing the network. Within each period there are Lₘₐₓ SSBs, where Lₘₐₓ depends on the carrier frequency.

Generally, SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. The SSB indices transmitted are provided by ssb-PositionsInBurst in system information block one (SIB1) or in ServingCellConfigCommon or in SSB-MTC-AdditionalPCI or in LTM-SSB-Config.

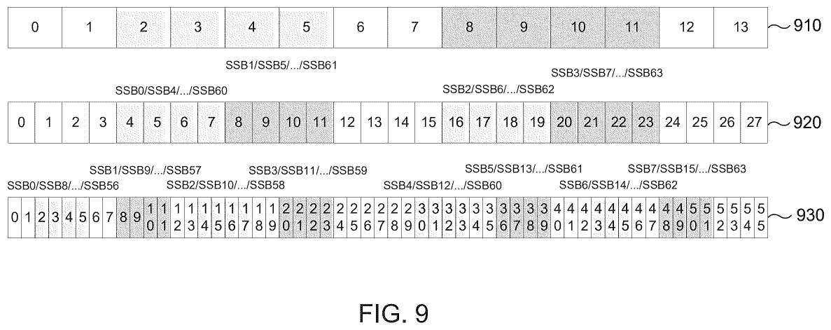

FIGS. 8 and 9 illustrate example SSB patterns 810-830 and 910-930, respectively, according to embodiments of the present disclosure. More particularly, FIG. 8 illustrates example SSB patterns for frequency range 1 (FR1) and FIG. 9 illustrates example SSB patterns for frequency range 2 (FR2). For example, the SSB patterns can be implemented by BS 102 and utilized by any one of the UEs 111-116 of FIG. 1. These examples are for illustration only and other embodiments can be used without departing from the scope of the present disclosure.

For carrier frequencies less than or equal to 3 GHZ, N=4. For carrier frequencies in FR1 that are larger than 3 GHZ, N=8. For FR1, the reference sub-carrier spacing (SCS) for the SSB design is 15 kHz. FIG. 8 illustrates the SSB structure within a 15 kHz slot that includes SSBs. For 15 kHz, there can be two SSBs in a 15 kHz slot, and there is one pattern, pattern 810 in FIG. 8. For 30 kHz, there can be four SSBs in a 15 kHz slot, for sub-carrier spacing 30 kHz, there are two patterns, pattern 820 and pattern 830 in FIG. 8.

For carrier frequencies in FR2, N=64. For FR2, the reference SCS for the SSB design is 60 kHz. FIG. 9 illustrates the SSB structure within a 60 kHz slot that includes SSBs. For 60 kHz, there can be two SSBs in a 60 kHz slot, and there is one pattern, pattern 910 in FIG. 9. For 120 kHz, there can be four SSBs in a 60 kHz slot with one pattern, pattern 920 in FIG. 9. For 240 kHz, there can be eight SSBs in a 60 kHz slot with one pattern, pattern 930 in FIG. 9.

As noted above, SSBs are transmitted periodically, where the allowed periodicities are T∈{5, 10, 20, 40, 80, 160} ms. When the SSB periodicity is larger than or equal to 10 ms, SSBs are transmitted in the first half of radio frames with SFN mod T=0, where SFN is the system frame number.

In addition to cell search, SSBs can also be used for connected mode mobility (e.g., handover), idle mode mobility (e.g., cell reselections), inter-RAT mobility to NR, and beam management related procedures, such as new beam acquisition, beam measurements, and beam failure detection and recovery. Each SSB with index i can be associated with a spatial domain filter (or beam).

NR introduced a PRACH to be used, among other cases, when the UE wants to communicate with the network and does not have uplink resources. For example, the PRACH can be used during initial access. The PRACH consists of a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources referred to as ROs. Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format.

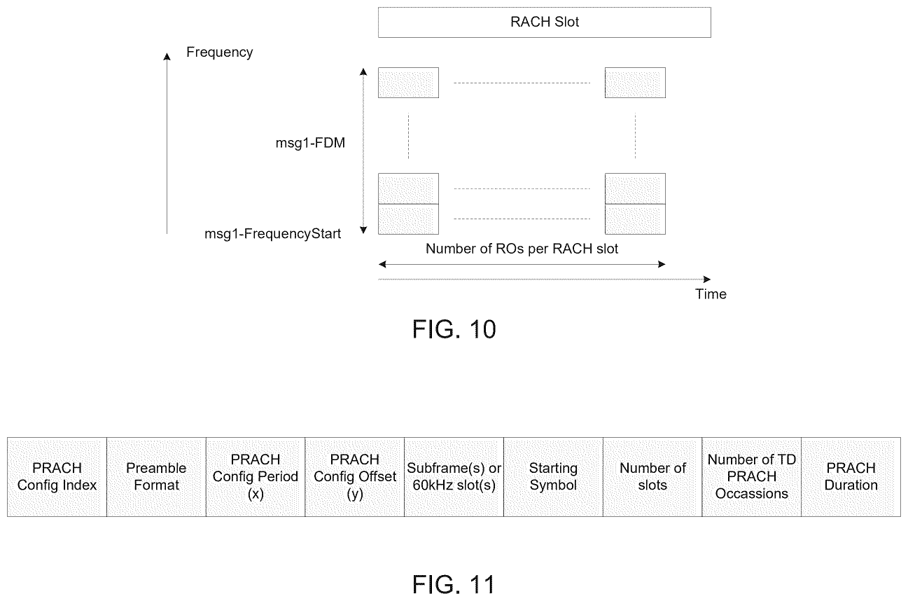

FIG. 10 illustrates an example of ROs according to embodiments of the present disclosure. More particularly, FIG. 10 illustrates an example of frequency division multiplexed (FDMed) and time division multiplexed (TDMed) ROs in a PRACH slot. For example, the ROs can be configured by BS 102 of FIG. 1. This example is for illustration only and other embodiments can be used without departing from the scope of the present disclosure.

As illustrated in FIG. 10, multiple PRACH Occasions can be FDMed in one time instance. This is indicated by higher layer parameter msg1-FDM for 4-step RACH or msgA-RO-FDM for 2-step RACH. The time instances of the PRACH Occasions are determined by the higher layer parameter prach-ConfigurationIndex, and Tables 6.3.3.2-2, 6.3.3.2-3, and 6.3.3.2-4 of REF 1. The PRACH configuration tables of REF 1 provide, based on a configured PRACH configuration index, various parameters.

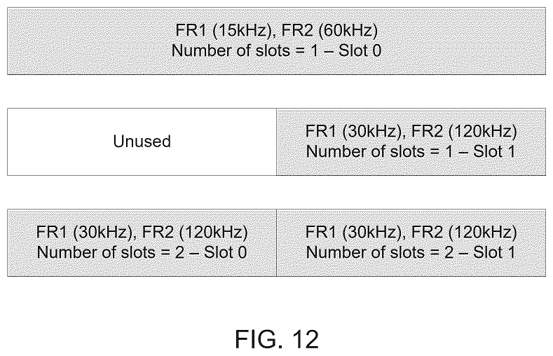

FIG. 11 illustrates example parameters for PRACH configuration according to embodiments of the present disclosure. For example, the parameters can be utilized by any one of the UEs 111-116 of FIG. 1. This example is for illustration only and other embodiments can be used without departing from the scope of the present disclosure.

In FIG. 11, the “PRACH configuration index” is an index, e.g., in the range 0 to 255 for 4-step RACH or in the range 0 to 262 for 2-step RACH provided by higher layers and refers to an entry in one of the PRACH configuration tables of REF 1. The selection of a Table from the PRACH configuration tables of REF 1 depends on the frequency range, FR1 or FR2, and depends on whether the spectrum used for PRACH transmissions is unpaired (e.g., time division duplex (TDD)), or pair (e.g., frequency division duplex (FDD)). In FR1, the PRACH preamble has a sub-carrier spacing of 15 kHz or 30 kHz. In FR2, the PRACH preamble has a sub-carrier spacing 60 kHz or 120 kHz. The “preamble format” can be long preamble format, e.g., preamble Format 0, 1, 2, or 3 in FR1 or FR2. Alternatively, the “preamble format” is short preamble format, e.g., preamble Format, A1, A2, A3, B1, B2, B3, B4, C0 and C2 in FR2. A PRACH is transmitted in a PRACH frame within a PRACH configuration period. The “PRACH configuration period x” can be x∈{10, 20, 40, 80, 160} ms. The PRACH frame has an offset of y frames within the PRACH configuration period. The start of the PRACH configuration period is aligned with system frame number (SFN) 0. The “subframe(s) or 60 kHz slot(s)” provides a list of subframes (for FR1) or 60 kHz slots (for FR2) that have PRACH.

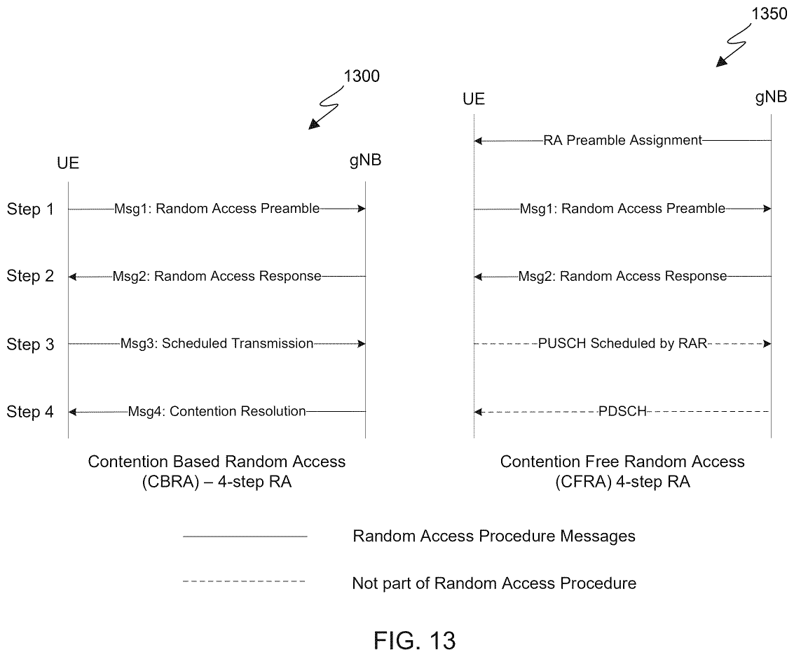

FIG. 12 illustrates examples of subframe or 60 kHz slot utilization for PRACH based on the sub-carrier spacing of the PRACH according to embodiments of the present disclosure. For example, the subframe or 60 kHz slot utilization for PRACH can be implemented by any one of the UEs 111-116 of FIG. 1. These examples are for illustration only and other embodiments can be used without departing from the scope of the present disclosure.

As illustrated in FIG. 12, if PRACH has a sub-carrier spacing of 15 kHz (in FR1) or 60 kHz (in FR2), there can be one slot in a subframe (FR1) or one slot in a 60 kHz slot (FR2), hence the “number of slots” (in FIG. 11) is 1. If PRACH has a sub-carrier spacing of 30 kHz (in FR1) or 120 kHz (in FR2), there can be two slots in a subframe (FR1) or two slots in a 60 kHz slot (FR2), hence the “number of slots” can be 1 or 2. If the number of slots is one, the PRACH slot is the second slot of the sub-frame (FR1) or the second slot of the 60 kHz slot (FR2). If the number of slots is two, then both slots of the sub-frame (FR1) or both slots of the 60 kHz slot (FR2) are PRACH slots.

Referring once again to FIG. 11, the “starting symbol” provides the first symbol of an earliest PRACH occasion in a PRACH slot. The “Number of TD PRACH Occasions” provides the number of PRACH occasions in a PRACH slot. “PRACH Duration,” applies to short preamble formats and provides the number of symbols in a PRACH Occasion.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon or in SSB-MTC-AdditionalPCI or in LTM-SSB-Config are mapped to valid PRACH occasions in the following order [REF 3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

An association period, starting from frame 0, for mapping SS/PBCH blocks to PRACH occasions is the smallest value in a set determined by the PRACH configuration period according to Table 8.1-1 of REF 3 such that SS/PBCH blocks of an SS/PBCH block burst are mapped at least once to the PRACH occasions within the association period. An association pattern period includes one or more association periods and is determined so that a pattern between PRACH occasions and SS/PBCH blocks repeats at most every 160 msec.

A random access procedure can be initiated by a PDCCH order, by the MAC entity, or by RRC.

There are two types of random access procedures, Type-1 random access procedure and Type-2 random access procedure.

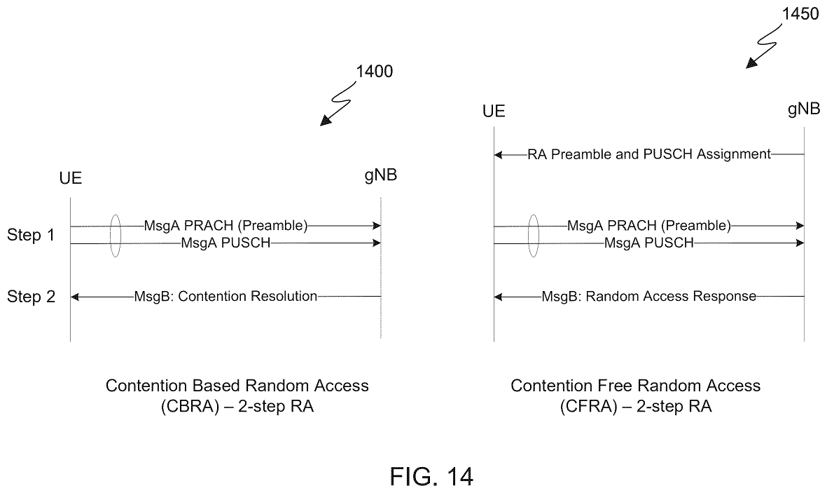

FIG. 13 illustrates examples of Type-1 random access procedures 1300 and 1350 according to embodiments of the present disclosure. For example, Type-1 random access procedures 1300 and 1350 can be implemented by BS 102 and any one of the UEs 111-116 of FIG. 1. These examples are for illustration only and other embodiments can be used without departing from the scope of the present disclosure.

A Type-1 random access procedure is known as the four-step random access procedure (4-step RACH). As illustrated in FIG. 13:
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and an uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup request message, allocates downlink and uplink resources that are transmitted in a downlink PDSCH transmission to the UE.

After the last step, the UE can proceed with reception and transmission of data traffic.

A Type-1 random access procedure (4-step RACH) can be contention based random access (CBRA) (i.e., Type-1 random access procedure 1300) or contention free random access (CFRA) (i.e., Type-1 random access procedure 1350). The CFRA procedure ends after the random access response, the following messages are not part of the random access procedure. For CFRA, in step 0, the gNB indicates to the UE the preamble to use. Rel-16 introduced another random access procedure.

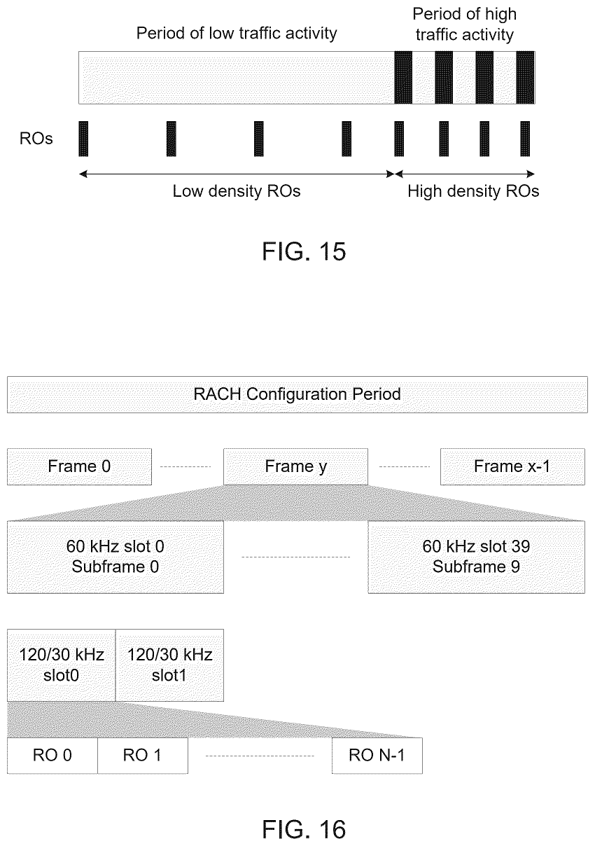

FIG. 14 illustrates examples of Type-2 random access procedures 1400 and 1450 according to embodiments of the present disclosure. For example, Type-2 random access procedures 1400 and 1450 can be implemented by BS 102 and any one of the UEs 111-116 of FIG. 1. These examples are for illustration only and other embodiments can be used without departing from the scope of the present disclosure.

A Type-2 random access procedure is known as the 2-step random access procedure (2-step RACH). As illustrated in FIG. 14, the procedure combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

A random access procedure can be triggered for initial access from the RRC IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access are used for subsequent transmissions and receptions to/from the UE until a single TCI state is configured or activated or indicated to the UE. For downlink receptions, when a UE does not have the TCI state, the spatial domain filter is that associated with the SS/PBCH block index identified during initial access. For uplink transmissions, when a UE does not have the TCI state, the spatial domain filter is that used for PUSCH scheduled by the RAR UL grant.

With light RACH traffic, PRACH configurations with sparse PRACH occasion (RO) density can be used for energy savings and overhead reduction. With heavy RACH traffic or for latency sensitive applications, PRACH configurations with dense PRACH occasion (RO) density can be used for reducing probability of collision and low latency. This disclosure considers the signaling and procedures for adaptation of PRACH configurations as well as on-demand PRACH configurations.

Further, this disclosure considers energy efficient and low overhead design of physical random access channel and for a random access procedure. As aforementioned, in NR, PRACH occasions (ROs) are configured for transmission of PRACH. ROs are associated with SS/PBCH blocks (SSBs), wherein the number of SSBs per RO can be

$${N}_{R O}^{S S B}$$

⅛, ¼, ½, 1, 2, 4, 8, 16}. The density of ROs (e.g., how frequent ROs occur) is a trade-off between latency/collision probability on one side and overhead and energy consumption on the other side. The more the number of ROs configured per time interval (RO density), the lower the latency, as the UE can find an RO sooner to transmit the PRACH, however, the higher the overhead and energy consumption for candidate PRACH receptions at the gNB. The gNB is expected to receive each RO and detect the presence of any PRACH preamble transmitted, whether or not there is a PRACH transmission for a UE. The more the number of ROs configured per time interval, the more processing the gNB would have to do to process the ROs. For contention-based preamble transmission, lowering the number of ROs can increase the probability of preamble collisions. A preamble collision can occur when two or more UEs select a same preamble in a same RO, as the density of ROs decreases, the probability that a UE selects a particular preamble in an RO for transmission increases, hence the probability of collision between two UEs using the same preamble and in the same RO increases.

In wireless networks, traffic varies over time. For example, a number of UEs served by a small cell can increase due to offloading from a macro cell or can decrease due to mobility. As such, the ability to dynamically change, the PRACH configuration to adapt to traffic/channel conditions, such as by L1 or L2 signaling respectively corresponding to a PDCCH/DCI format or a MAC CE, may be desirable. Further, slow rate RACH reconfigurations can be accomplished by SIB or RRC reconfiguration. This disclosure considers signaling for dynamic adaptation of PRACH configuration as well as associated parameters to adapt.

In many wireless applications, such as messaging applications, internet-of-things applications, etc., traffic transmitted over the network has bursty characteristics.

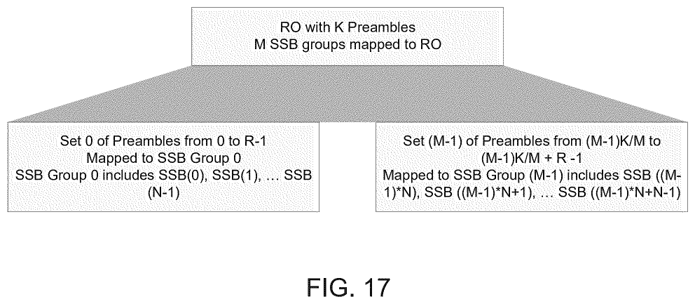

FIG. 15 illustrates an example of the traffic activity being transmitted over a network in a wireless communication system according to embodiments of the present disclosure. For example, the traffic activity of FIG. 15 could be the traffic activity being transmitted over wireless network 100 of FIG. 1. This example is for illustration only and other embodiments can be used without departing from the scope of the present disclosure.

As illustrated in FIG. 15, there can be long periods of silence and then traffic transmitted periodically or quasi-periodically for a period of time, then followed again by a period of silence. For such scenarios, data packets can be small in size (small data transmission (SDT)) and can be transmitted using a random access procedure. In one example, type-2 random access, also known as two-step RACH can be used, wherein a preamble is transmitted (MsgA PRACH) followed by a PUSCH transmission (MsgA PUSCH) with the data. In another example, type-1 random access procedure, also known as four-step RACH, can also be used for small data transmission, wherein the data can be included in Msg3. The time-domain density of the ROs used for two-step RACH or four-step RACH impact the overall system performance. There is a tradeoff between latency and energy efficiency/overhead. When the ROs are sparse in time-domain, energy efficiency improves, however this is at the expense of more latency, and vice versa when ROs are dense in time domain. As aforementioned, traffic is bursty in nature, and as illustrated in FIG. 15, there can be long periods of silence followed by periods of increased activity. As such, having adaptable or multiple PRACH configurations, with different time domain density and activate or deactivate of a PRACH configuration based on current traffic characteristics, is reasonable. The activation/deactivation or request for activation/deactivation can be done by the network or the UE. This disclosure considers procedures and signaling for multiple and adaptable PRACH configurations.

The network can support different types of UEs with different capabilities. The PRACH configuration can depend on the capabilities of the UEs served. For example, if there are UEs with a small maximum bandwidth capability, the number of configured FDMed ROs is limited so as not to exceed the maximum UE's bandwidth capability. The network can configure multiple PRACH configurations according to the UE's capabilities and activate a corresponding PRACH configuration based on the capabilities of the UEs performing random access in the cell. In one example, as described in this disclosure, a UE can request a PRACH based on its capability and/or traffic characteristics.

Long PRACH formats can be configured with different restricted set types, e.g., unrestricted sets or restricted sets Type-A or restricted sets Type-B. The restricted set type to use depends on the maximum Doppler shift of the PRACH signal, which depends on the UEs speed. The network can configure multiple PRACH configurations according to the UE's speed. In one example, a UE can request a PRACH configuration for an unrestricted/restricted set type. In one example, based on the speed of UEs performing random access in a cell, the network can activate a PRACH configuration with a corresponding unrestricted/restricted set type.

Dynamic (DCI format based or MAC CE based) adaptation of PRACH configuration can achieve a desired trade-off between latency/collision probability on one side and overhead reduction/energy savings on the other side, with changing traffic/channel conditions, another way to achieve the same objective is to enable on-demand ROs. For on-demand ROs, the presence on the ROs can be triggered, when needed (e.g., based on traffic conditions for SDT), by the network or by the UE. This disclosure considers procedures and signaling aspects for triggering on-demand ROs.

Generally, the present disclosure considers aspects related to energy efficient RACH design. More particularly, the present disclosure considers:
Adaptation of PRACH configuration parameters.
Signaling for PRACH configuration adaptation as well as timing aspects related to the application of new PRACH configurations.
Signaling and procedures for on-demand ROs.

In the following, both FDD and TDD are considered as a duplex method for DL and UL signaling. In addition, full duplex (XDD) operation is possible, e.g., sub-band full duplex (SBFD) or single frequency full duplex (SFFD).

Although the present disclosure and the various embodiments herein assume orthogonal frequency division multiplexing (OFDM) or orthogonal frequency division multiple access (OFDMA), as noted above, this disclosure can be extended to other OFDM-based transmission waveforms or multiple access schemes such as filtered OFDM (F-OFDM).

This disclosure considers several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE and can be UE common (e.g., to a group of UEs). MAC CE signaling can be DL MAC CE signaling or UL MAC CE signaling.

In this disclosure L1 control signaling includes: (1) DL control information (e.g., DCI on PDCCH or DL control information on PDSCH or sequence-based DL control information) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format or sequence-based) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as SS/PBCH block, PSS, SSS, PBCH, RACH, PRACH, RO, WUS, and other terms is used for illustrative purposes and is therefore not normative. Other terms that refer to same functions can also be used.

For Type-1 random access procedure (e.g., 4-step RACH), IE RACH-ConfigGeneric is used to specify the random-access parameters both for regular random access as well as for beam failure recovery. IE RACH-ConfigGeneric provides the following parameters:
prach-ConfigurationIndex, which provides an index from 0 to 255 to determine a row in one of the PRACH configuration tables of REF 1 as aforementioned. This entry determines the preamble format and the time domain ROs.
msg1-FDM, which determines the number of PRACH transmission occasions FDMed in one time instance.
msg1-FrequencyStart, which determines offset of lowest PRACH transmission occasion in frequency domain with respect to PRB 0. The value is configured so that the corresponding RACH resource is entirely within the bandwidth of the UL BWP.
zeroCorrelationZoneConfig, which provides an index from 0 to 15 that determines the N-CS configuration.
preambleReceivedTargetPower, which provides the target power level at the network receiver side.
preambleTransMax, which provides the maximum number of RA preamble transmission performed before declaring a failure.
powerRampingStep, which provides the power ramping steps for PRACH.
ra-ResponseWindow, which provides Msg2 (RAR) window length in number of slots.
IAB related PRACH configuration parameters.

For Type-2 random access procedure (e.g., 2-step RACH), IE RACH-ConfigGenericTwoStepRA is used to specify the 2-step random access type parameters. The parameters of RACH-ConfigGenericTwoStepRA are similar to the parameters of RACH-ConfigGeneric. The msgA-PRACH-ConfigurationIndex (analogous to prach-ConfigurationIndex in RACH-ConfigGeneric) has a range from 0 to 262. IE RACH-ConfigGenericTwoStepRA does not have IAB related PRACH configuration parameters.

IE RACH-ConfigGeneric and IE RACH-ConfigGenericTwoStepRA can be included in the following PRACH configuration IEs to provide random access parameters:
IE BeamFailureRecoveryConfig for configuring the UE with RACH resources and candidate beams for beam failure recovery in case of beam failure detection.
IE EarlyUL-SyncConfig for configuring random access resources for the early UL synchronization procedure (e.g., for L1/L2 triggered mobility (LTM)).
IE RACH-ConfigCommon for configuring cell specific 4-step random-access parameters.
IE RACH-ConfigCommonTwoStepRA for configuring cell specific 2-step random-access type parameters.
IE RACH-ConfigDedicated for configuring dedicated 2-step or 4-step random access parameters.
IE RACH-ConfigTwoTA for configuring random access parameters for each additional PCI configured for the serving cell.
IE SI-RequestConfig for configuring parameters for Msg1 based SI request without Msg1 repetition.
IE SI-RequestConfigRepetition for configuring parameters related to Msg1 based SI request with Msg1 repetition.

The aforementioned IEs for PRACH configurations can provide the following parameters, in addition to the parameters provided by IE RACH-ConfigGeneric and IE RACH-ConfigGenericTwoStepRA:
totalNumberOfRA-Preambles
ssb-perRACH-Occasion
CB-PreamblesPerSSB
SSB or CSI-RS resource list for association with ROs
msgA-CB-PreamblesPerSSB-PerSharedRO
msgA-SSB-SharedRO-MaskIndex
msg1 or msgA-SubcarrierSpacing
prach-RootSequenceIndex
msg3-transformPrecoder
groupBconfigured
ra-ContentionResolutionTimer
msgA-TransMax
rsrp-ThresholdSSB
rsrp-ThresholdSSB-SUL
ra-PrioritizationForAccessIdentity
ra-PrioritizationForSlicing
featureCombinationPreamblesList
ra-MsgA-SizeGroupA
messagePowerOffsetGroupB
numberOfRA-PreamblesGroupA
SI-RequestPeriod
SI-RequestResources
si-RequestResourcesRepetitionNum2/4/8

In one example, the following parameters can be adapted:
Parameters that determine the time domain ROs
Parameters that determine the frequency domain ROs
Parameters related to code domain
Parameters related to power domain
Parameters related to SSB-RO association
Other RACH related parameters

The time domain parameters for PRACH configuration can be determined based on the prach-ConfigurationIndex for Msg1 (e.g., 4-step RACH) or MsgA (e.g., 2-step RACH). The prach-ConfigurationIndex provides a pointer to one of the rows of the PRACH configuration tables (Tables 6.3.3.2-2, 6.3.3.2-3, and 6.3.3.2-4) of REF 1.

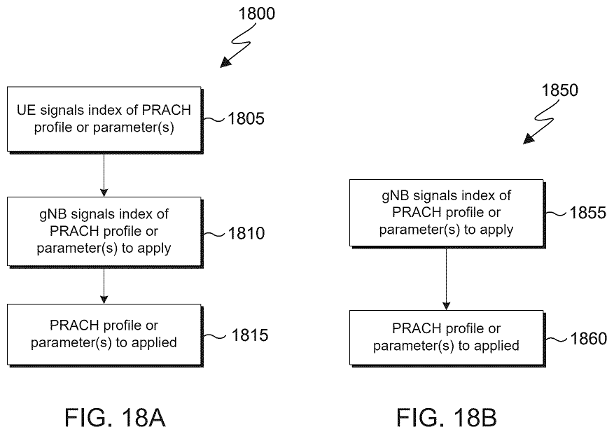

FIG. 16 illustrates an example of time domain parameters for PRACH configuration according to embodiments of the present disclosure. For example, the time domain parameters for PRACH configuration can be utilized by any one of the UEs 111-116 of FIG. 1. This example is for illustration only and other embodiments can be used without departing from the scope of the present disclosure.

As illustrated in FIG. 16, the PRACH configuration index can determine the PRACH configuration period (e.g., parameter x in the tables of REF 1), and the RACH frame offset (e.g., parameter y in the tables of REF 1). The PRACH configuration index also determines the subframes or 60 kHz slots that contain RACH, the number of RACH slots in a RACH subframe or in a RACH 60 kHz slot, the starting symbol for RACH in a RACH slot and the number of ROs in a RACH slot.

In one example, to signal a new time domain RO configuration, a different PRACH configuration index is signaled to the UE. In one example, the new and old PRACH configuration indexes have a same preamble format. In one example, the new and old PRACH configuration index can have different preamble formats.

In one example, to signal a new time domain RO configuration, a value for one or more of the following parameters can be signaled to the UE:
Frame periodicity or frame offset
Sub-frames or 60 kHz slots or other time unit with ROs
Starting symbol in RACH slot. A RACH a slot is a slot, where there are ROs
Number of RACH slots in a subframe or 60 kHz slot
Number of ROs per RACH slot. In one example, a bitmap can provide ROs in a slot.

In one example, a PRACH configuration is provided by the SIB, e.g., SIB1 or SIBx. In one example, based on the PRACH configuration provided in the SIB, the UE determines the time domain ROs within a time interval. In one example, the time interval is the PRACH configuration period. In one example, the time interval is the association period. In one example, the time interval is the association pattern period. In one example, the UE can be signaled a subset of time domain ROs within the time interval that are available for RACH transmission. In one example, the UE can be signaled a subset of time domain ROs within the time interval that are not available for RACH transmission (e.g., DRXed by the gNB). In one example, the UE is signaled a number L where L is the number of times an SS/PBCH Block is associated with an RO, after L association of SS/PBCH Blocks to ROs within the time interval, the remaining ROs in the time interval are left unused.

In one example, the time domain ROs (TDROs) that are available or not available within the time interval are provided by a bitmap, e.g., a value of “1” indicates that corresponding TDRO is available, and a value of “0” indicates that the corresponding TDRO is not available. Alternatively, a value of “1” indicates that corresponding TDRO is not available, and a value of “0” indicates that the corresponding TDRO is available. In one example, each TDRO in the time interval corresponds to a bit in the bitmap, with the earliest TDRO corresponding to the MSB and the second earliest TDRO in the time interval corresponding to the second MSB and so on. In one example, each TDRO in the time interval corresponds to a bit in the bitmap, with the earliest TDRO in the time interval corresponding to the LSB and the second earliest TDRO corresponding to the second LSB and so on. In one example, number of bits in the bitmap equals the number of TDROs in the time interval. In one example, the ordering of the TDROs is first in order of TDROs of RACH slots and then in order of RACH slots starting with the earliest (or latest) TDRO in the time interval.

To illustrate the bitmap by a way of example, a time-interval can be PRACH configuration interval. The PRACH configuration period includes N TDROs, for example {TDRO₀, TDRO₁, . . . . TDRO_{N-1}} a bitmap of size N can indicate which TDRO is active in this set for example the bitmap is b₀b₁ . . . b_{N-1}, where bit bₙ corresponds to TDROₙ, if bit bₙ is 1, TDROₙ is active, if bit bₙ is OTDROₙ is not active. In a variant example, the role of 1 and 0 can be reversed. In one example, as described later, the bitmap can be provided by L1 control (e.g., DCI Format or sequence-based), e.g., a DCI format with CRC scrambled by RNTI and the RNTI is UE-group common (for a UE group) or cell common (for UEs in a cell) or UE-specific (for a specific UE). In one example, the bitmap can be provided by MAC CE or RRC or SIB.

In one example, the TDROs that are available or not available within the time interval are provided by a list, e.g., a list of TDROs that are available or not available within the time interval, wherein a TDRO can be identified by an index, wherein the index can be a counter of the TDRO, starting from 0 for earliest TDRO in the time interval and then incrementing the counter for each later TDRO in the time interval, alternatively, starting from 0 for latest TDRO in the time interval and then incrementing the counter for each earlier TDRO in the time interval. In one example, the size of the list equals the number of TDROs that are signaled as available or not available. In one example, the ordering of the TDROs is first in order of TDROs of RACH slots and then in order of RACH slots starting with the earliest (or latest) TDRO in the time interval. In one example, a TDRO can be identified by a TDRO index within a RACH slot and a RACH slot index within the time interval. In one example, a TDRO can be identified by a TDRO index within a RACH slot and a RACH slot index within a subframe or 60 kHz slots and subframe/60 kHz slot index within the time interval.

In one example, the TDROs that are available are provided by a number of TDROs that are available at the start of the time interval, other TDROs in the time interval are not available. In one example, the TDROs that are available are provided by a number of TDROs that are available at the end of the time interval, other TDROs in the time interval are not available. In one example, the TDROs that are not available are provided by a number of TDROs that are not available at the start of the time interval, other TDROs in the time interval are available. In one example, the TDROs that are not available are provided by a number of TDROs that are not available at the end of the time interval, other TDROs in the time interval are available.

In one example, a PRACH configuration is provided by a SIB, e.g., SIB1 or SIBx. In one example, based on the PRACH configuration provided in the SIB, the UE determines the RACH slots within a time interval. In one example, the time interval is the PRACH configuration period. In one example, the time interval is the association period. In one example, the time interval is the association pattern period. In one example, the UE can be signaled a subset of RACH slots within the time interval that are available for PRACH transmission. In one example, the UE can be signaled a subset of RACH slots within the time interval that are not available for PRACH transmission (e.g., DRXed by the gNB).

In one example, the RACH slots that are available or not available within the time interval are provided by a bitmap, e.g., a value of “1” indicates that corresponding RACH slot is available, and a value of “0” indicates that the corresponding RACH slot is not available. Alternatively, a value of “1” indicates that corresponding RACH slot is not available, and a value of “O” indicates that the corresponding RACH slot is available. In one example, each RACH slot in the time interval corresponds to a bit in the bitmap, with the earliest RACH slot corresponding to the MSB and the second earliest RACH slot in the time interval corresponding to the second MSB and so on. In one example, each RACH slot in the time interval corresponds to a bit in the bitmap, with the earliest RACH slot in the time interval corresponding to the LSB and the second earliest RACH slot corresponding to the second LSB and so on. In one example, number of bits in the bitmap equals the number of RACH slots in the time interval, e.g., the counting is over the RACH slots in the time interval. In one example, number of bits in the bitmap equals the number of RACH slots in the time interval, e.g., the counting is over all (or all the UL) slots in the time interval.

In one example, the RACH slots that are available or not available within the time interval are provided by a list, e.g., a list of RACH slots that are available or not available within the time interval, wherein a RACH slot can be identified by an index, wherein the index can be a counter of the RACH slot, starting from 0 for earliest RACH slot in the time interval and then incrementing the counter for each later RACH slot in the time interval, alternatively, starting from for latest RACH slot in the time interval and then incrementing the counter for each earlier RACH slot in the time interval. In one example, the size of the list equals the number of RACH slots that are signaled as available or not available. In one example, a RACH slot can be identified by a RACH slot index within a subframe or 60 kHz slots and subframe/60 kHz slot index within the time interval.

In one example, the RACH slots that are available are provided by a number of RACH slots that are available at the start of the time interval, other RACH slots in the time interval are not available. In one example, the RACH slots that are available are provided by a number of RACH slots that are available at the end of the time interval, other RACH slots in the time interval are not available. In one example, the RACH slots that are not available are provided by a number of RACH slots that are not available at the start of the time interval, other RACH slots in the time interval are available. In one example, the RACH slots that are not available are provided by a number of RACH slots that are not available at the end of the time interval, other RACH slots in the time interval are available. In one example, the RACH slots that are available are provided by a number of slots that are available at the start of the time interval, other slots in the time interval are not available. In one example, the RACH slots that are available are provided by a number of UL slots that are available at the start of the time interval, other UL slots in the time interval are not available. In one example, a number of slots not available for RACH is provided, and this corresponds to the slots at the start of the time interval, other slots in the time interval are available for RACH. In one example, a number of UL slots not available for RACH is provided, and this corresponds to the UL slots at the start of the time interval, other UL slots in the time interval are available for RACH.

In one example, a PRACH configuration is provided by a SIB, e.g., SIB1 or SIBx. In one example, based on the PRACH configuration provided in the SIB, the UE determines the RACH subframes or 60 kHz slots within a time interval. In one example, the time interval is the PRACH configuration period. In one example, the time interval is the association period. In one example, the time interval is the association pattern period. In one example, the UE can be signaled a subset of RACH subframes or 60 kHz slots within the time interval that are available for RACH transmission. In one example, the UE can be signaled a subset of RACH subframes or 60 kHz slots within the time interval that are not available for RACH transmission (e.g., DRXed by the gNB).

In one example, the RACH subframes or 60 kHz slots that are available or not available within the time interval are provided by a bitmap, e.g., a value of “1” indicates that corresponding RACH subframe or 60 kHz slot is available, and a value of “0” indicates that the corresponding RACH subframe or 60 kHz slot is not available. Alternatively, a value of “1” indicates that corresponding RACH subframe or 60 kHz slot is not available, and a value of “0” indicates that the corresponding RACH subframe or 60 kHz slot is available. In one example, each RACH subframe or 60 kHz slot in the time interval corresponds to a bit in the bitmap, with the earliest RACH subframe or 60 kHz slot corresponding to the MSB and the second earliest RACH subframe or 60 kHz slot in the time interval corresponding to the second MSB and so on. In one example, each RACH subframe or 60 kHz slot in the time interval corresponds to a bit in the bitmap, with the earliest RACH subframe or 60 kHz slot in the time interval corresponding to the LSB and the second earliest RACH subframe or 60 kHz slot corresponding to the second LSB and so on. In one example, number of bits in the bitmap equals the number of RACH subframes or 60 kHz slots in the time interval, e.g., the counting is over the RACH subframes or the RACH 60 kHz slots in the time interval. In one example, number of bits in the bitmap equals the number of RACH subframes or 60 kHz slots in the time interval, e.g., the counting is over all (or all the UL) subframes or all (or all the UL) 60 kHz slots in the time interval.

In one example, the RACH subframes or 60 kHz slots that are available or not available within the time interval are provided by a list, e.g., a list of RACH subframes or 60 kHz slots that are available or not available within the time interval, wherein a RACH subframe or 60 kHz slot can be identified by an index, wherein the index can be a counter of the RACH subframe or 60 kHz slot, starting from 0 for earliest RACH subframe or 60 kHz slot in the time interval and then incrementing the counter for each later RACH subframe or 60 kHz slot in the time interval, alternatively, starting from 0 for latest RACH subframe or 60 kHz slot in the time interval and then incrementing the counter for each earlier RACH subframe or 60 kHz slot in the time interval. In one example, the size of the list equals the number of RACH subframes or 60 kHz slots that are signaled as available or not available.

In one example, the RACH subframes or 60 kHz slots that are available are provided by a number of RACH subframes or 60 kHz slots that are available at the start of the time interval, other RACH subframes or 60 kHz slots in the time interval are not available. In one example, the RACH subframes or 60 kHz slots that are available are provided by a number of RACH subframes or 60 kHz slots that are available at the end of the time interval, other RACH subframes or 60 kHz slots in the time interval are not available. In one example, the RACH subframes or 60 kHz slots that are not available are provided by a number of RACH subframes or 60 kHz slots that are not available at the start of the time interval, other RACH subframes or 60 kHz slots in the time interval are available. In one example, the RACH subframes or 60 kHz slots that are not available are provided by a number of RACH subframes or 60 kHz slots that are not available at the end of the time interval, other RACH subframes or 60 kHz slots in the time interval are available. In one example, the RACH subframes or 60 kHz slots that are available are provided by a number of subframes or 60 kHz slots that are available at the start of the time interval, other subframes or 60 kHz slots in the time interval are not available. In one example, the RACH subframes or 60 kHz slots that are available are provided by a number of UL subframes or UL 60 kHz slots that are available at the start of the time interval, other UL subframes or UL 60 kHz slots in the time interval are not available. In one example, a number of subframes or 60 kHz slots not available for RACH is provided, and this corresponds to the subframes or 60 kHz slots at the start of the time interval, other subframes or 60 kHz slots in the time interval are available for RACH. In one example, a number of UL subframes or UL 60 kHz slots not available for RACH is provided, and this corresponds to the UL subframes or UL 60 kHz slots at the start of the time interval, other UL subframes or UL 60 kHz slots in the time interval are available for RACH.

In one example, the UE can be provided with a message that indicates the time domain parameters for PRACH configuration to apply (e.g., time domain ROs to use). In one example, the message is provided by SIB or RRC signaling. In one example, the message is MAC CE is L1 control (e.g., DCI Format or sequence-based). In one example, a message is transmitted (or addressed to) all UEs in a cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE-specific RNTI used to scramble the CRC of a DCI Format (1) scheduling the message, or (2) that contains the message, e.g., a DCI format with CRC scrambled by RNTI and the RNTI is UE-group common (for a UE group) or cell common (for UEs in a cell) or UE-specific (for a specific UE).

In one example, the UE can transmit an UL signal, e.g., using PUCCH or PUSCH or PRACH, and provide information about requested or preferred time domain parameters for PRACH configuration, e.g., based on latency requirements of the service the UE is providing. In response, the network can provide the UE with a message that indicates the time domain parameters for PRACH configuration to apply (e.g., time domain ROs to use) as aforementioned.

The frequency domain parameters for PRACH configuration can be determined based on higher layer parameters msg1-FDM and msg1-FrequencyStart for 4-step RACH, or based on higher layer parameters msgA-RO-FDM and msgA-RO-FrequencyStart for 2-step RACH.

In one example, the UE is provided with a message that indicates the new frequency domain parameters to apply for PRACH configuration. In one example, parameters can include one or more of msg1-FDM and msg1-Frequency Start for 4-step RACH and msg1-FDM and msg1-FrequencyStart for 4-step RACH. In one example, the frequency domain PRACH occasions provided to the UE are a subset of the frequency domain occasions provided in the PRACH configuration in the SIB, e.g., SIB1 or SIBx.

In one example, a PRACH configuration is provided by a SIB, e.g., SIB1 or SIBx. In one example, based on the PRACH configuration provided in the SIB, the UE determines the frequency domain ROs. In one example, the UE can be signaled a subset of frequency domain ROs within the time interval that are available for RACH transmission. In one example, the UE can be signaled a subset of frequency domain ROs that are not available for RACH transmission (e.g., DRXed by the gNB).

In one example, the frequency domain ROs (FDROs) that are available or not available within the time interval are provided by a bitmap, e.g., a value of “1” indicates that corresponding FDRO is available, and a value of “0” indicates that the corresponding FDRO is not available. Alternatively, a value of “1” indicates that corresponding FDRO is not available, and a value of “O” indicates that the corresponding FDRO is available. In one example, each FDRO corresponds to a bit in the bitmap, with the lowest frequency FDRO corresponding to the MSB and the second lowest frequency FDRO corresponding to the second MSB and so on. In one example, each FDRO corresponds to a bit in the bitmap, with the lowest frequency FDRO corresponding to the LSB and the second lowest frequency FDRO corresponding to the second LSB and so on. In one example, number of bits in the bitmap equals the number of FDROs. In one example, the ordering of the FDROs is in order of increasing (or decreasing) frequency.

In one example, the FDROs that are available or not available are provided by a list, e.g., a list of FDROs that are available or not available, wherein a FDRO can be identified by an index, wherein the index can be a counter of the FDRO, starting from 0 for lowest frequency FDRO and then incrementing the counter for each later FDRO in frequency, alternatively, starting from 0 for highest frequency FDRO and then incrementing the counter for each earlier FDRO in frequency. In one example, the size of the list equals the number of FDROs that are signaled as available or not available. In one example, the ordering of the FDROs is in order of increasing (or decreasing) frequency.

In one example, the FDROs that are available are provided by a number of FDROs that are available at the start of the RACH frequency allocation, other FDROs in the RACH frequency allocation are not available. In one example, the FDROs that are available are provided by a number of FDROs that are available at the end of the RACH frequency allocation, other FDROs in the RACH frequency allocation are not available. In one example, the FDROs that are not available are provided by a number of FDROs that are not available at the start of the RACH frequency allocation, other FDROs in the RACH frequency allocation are available. In one example, the FDROs that are not available are provided by a number of FDROs that are not available at the end of the RACH frequency allocation, other FDROs in the RACH frequency allocation are available.

In one example, a PRACH configuration is provided by the SIB. In one example, based on the PRACH configuration provided in the SIB, the UE determines the ROs (e.g., in time and frequency) within a time interval. In one example, the time interval is a RACH slot. In one example, the time interval is a RACH sub-frame or 60 kHz slot. In one example, the time interval is the PRACH configuration period. In one example, the time interval is the association period. In one example, the time interval is the association pattern period. In one example, the UE can be signaled a subset of ROs within the time interval that are available for RACH transmission. In one example, the UE can be signaled a subset of ROs within the time interval that are not available for RACH transmission (e.g., DRXed by the gNB). In one example, the UE is signaled a number L where L is the number of times an SS/PBCH Block is associated with an RO, after L association of SS/PBCH Blocks to ROs within the time interval, the remaining ROs in the time interval are left unused.

In one example, the ROs that are available or not available within the time interval are provided by a bitmap, e.g., a value of “1” indicates that corresponding RO is available, and a value of “0” indicates that the corresponding RO is not available. Alternatively, a value of “1” indicates that corresponding RO is not available, and a value of “0” indicates that the corresponding RO is available. In one example, each RO in the time interval corresponds to a bit in the bitmap, with the earliest and lowest frequency RO corresponding to the MSB and then ROs are indicated in increasing frequency followed by increasing time, or in increasing time followed by increasing frequency. In one example, each RO in the time interval corresponds to a bit in the bitmap, with the earliest and lowest frequency RO in the time interval corresponding to the LSB and then ROs go increasing frequency followed by increasing time, or in increasing time followed by increasing frequency. In one example, number of bits in the bitmap equals the number of ROs in the time interval. In one example, the ordering of the ROs is first in order of frequency, then in order of TDROs of a RACH slot and then in order of RACH slots starting with the lowest (or highest frequency RO and starting with the earliest (or latest) RO in the time interval.

In one example, the ROs that are available or not available within the time interval are provided by a list, e.g., a list of ROs that are available or not available within the time interval, wherein a RO can be identified by an index, wherein the index can be a counter of the RO, starting from 0 for earliest and lowest frequency RO in the time interval and then incrementing the counter for each later or higher frequency RO in the time interval, first in order of frequency followed by time or first in order of time followed by frequency, alternatively, starting from 0 for latest and highest frequency RO in the time interval and then incrementing the counter for each earlier or lower frequency RO in the time interval, first in order of frequency followed by time or first in order of time followed by frequency. In one example, the size of the list equals the number of ROs that are signaled as available or not available. In one example, the ordering of the ROs is first in order of frequency, then in order of ROs of RACH slots and then in order of RACH slots starting with the lowest (or highest frequency RO and starting with the earliest (or latest) RO in the time interval. In one example, a RO can be identified by a RO index within a RACH slot and a RACH slot index within the time interval. In one example, a RO can be identified by a RO index within a RACH slot and a RACH slot index within a subframe or 60 kHz slots and subframe/60 kHz slot index within the time interval. In one example, the RO index within a slot is identified by a frequency component (RO number in frequency domain) and a time component (RO number in time domain within a slot).

In one example, the ROs that are available are provided by a number of ROs that are available at the start of the time interval, other ROs in the time interval are not available. In one example, the ROs that are available are provided by a number of ROs that are available at the end of the time interval, other ROs in the time interval are not available. In one example, the ROs that are not available are provided by a number of ROs that are not available at the start of the time interval, other ROs in the time interval are available. In one example, the ROs that are not available are provided by a number of ROs that are not available at the end of the time interval, other ROs in the time interval are available. In one example, the ordering of the ROs is first in order of frequency, then in order of ROs of RACH slots and then in order of RACH slots starting with the lowest (or highest) frequency RO and starting with the earliest (or latest) RO in the time interval.

In one example, the UE can be provided with a message that indicates the frequency domain parameters for PRACH configuration to apply (e.g., ROs or frequency domain ROs to use). In one example, the message is provided by SIB or RRC signal. In one example, the message is MAC CE is L1 control (e.g., DCI Format or sequence-based). In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message. e.g., a DCI format with CRC scrambled by RNTI and the RNTI is UE-group common (for a UE group) or cell common (for UEs in a cell) or UE-specific (for a specific UE).

In one example, the UE can transmit an UL signal, e.g., using PUCCH or PUSCH or PRACH, and provide information about requested or preferred frequency domain parameters for PRACH configuration, e.g., based on latency requirements of the service the UE is providing, or based on the type of UE (e.g., low-bandwidth or high-bandwidth UE). For example, a set of PRACH preambles can be associated through a one-to-one mapping with a set of PRACH configurations or a PRACH configuration from the PRACH configurations can be indicated by information bits in a PUSCH or PUCCH through a one-to-one mapping among a set of values for the information bits and a set of PRACH configurations. In response, the network can provide the UE with a message that indicates the frequency domain parameters for PRACH configuration to apply (e.g., frequency domain ROs to use) as aforementioned.

The code domain parameters for PRACH configuration can include:
zeroCorrelationZoneConfig:
   Parameter range: 0 . . . 15. In one example, the value of this parameter depends on the cell radius.
   In one example, zeroCorrelationZoneConfig determines the cyclic shift (N_CS). In one example, the cyclic shift determines the number of PRACH root sequences used.
   In one example, a UE can be signaled a message that indicates the zeroCorrelationZoneConfig to apply for new PRACH configuration. In one example, if the cell radius for PRACH changes, the UE can be signaled a message with a new zeroCorrelationZoneConfig determined based on the cell radius.
prach-RootSequenceIndex
   In one example, a UE can be signaled a message that indicates the prach-RootSequenceIndex to apply for new PRACH configuration. In one example, the prach-RootSequenceIndex can be changed for interference avoidance with other cells.
restrictedSetConfig
   Parameter range: Unrestricted or TypeA or TypeB
   In one example, the restrictedSetConfig applies to long preambles Formats.
   In one example, the configuration of restrictedSetConfig depends on UE speed in cell)
   In one example, a UE can be signaled a message that indicates the restrictedSetConfig to apply for new PRACH configuration.
Preamble Format
   In one example, the preamble format can't be changed.
   In one example, the preamble format can change, but with a same sequence length (e.g., either long preamble format or short preamble format).
   In one example, the preamble format can change, and the sequence length can change.
   In one example, a UE can be signaled a message that indicates a preamble format to apply for new PRACH configuration.
   In one example, a UE can be signaled a message that indicates a PRACH configuration index, and the PRACH configuration index indicates a new preamble format.
   In one example, the type of UE or coverage requirement of UE determines the preamble format. For example, the UE can send an UL signal (e.g., PUCCH or PUSCH or PRACH) that informs the network of a preferred type of preamble.

In one example, the UE can be provided with a message that indicates the code domain parameters for PRACH configuration to apply. In one example, the message is provided by SIB or RRC signal. In one example, the message is MAC CE is L1 control (e.g., DCI Format or sequence-based). In one example, a message is transmitted (or addressed to) all UEs in a cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example, the UE can transmit an UL signal, e.g., using PUCCH or PUSCH or PRACH, and provide information about requested or preferred code domain parameters for PRACH configuration, e.g., as previously described and based on latency requirements of the service the UE is providing, or based on the type of UE. The code domain parameters are as aforementioned. In response, the network can provide the UE with a message that indicates the code domain parameters for PRACH configuration to apply.

The power domain parameters for PRACH configuration can include
preamble TargetReceivedPower
   Range: −202, 200, . . . , −60
   In one example, a UE can be signaled a message that indicates the preambleTargetReceivedPower to apply for new PRACH configuration.
powerRampingStepSize
   Range: {0, 2, 4, 6} dB respectively
   In one example, a UE can be signaled a message that indicates the powerRampingStepSize to apply for new PRACH configuration.
rsrp-ThresholdSSB and rsrp-ThresholdSSB-SUL
   In one example, a UE can be signaled a message that indicates the rsrp-ThresholdSSB and/or rsrp-ThresholdSSB-SUL to apply for new PRACH configuration.

In one example, the UE can be provided with a message that indicates the power domain parameters for PRACH configuration to apply. In one example, the message is provided by SIB or RRC signal. In one example, the message is MAC CE is L1 control (e.g., DCI Format). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example, the UE can transmit an UL signal, e.g., using PUCCH or PUSCH or PRACH, and provide information about requested or preferred power domain parameters for PRACH configuration, e.g., based on the type of services or the type of UE. For example, the information can be provided through a one-to-one mapping for a set of PRACH preambles to a set of PRACH configurations or through a one-to-one mapping of values of information bits in a PUSCH or PUCCH to a set of PRACH configurations. The power domain parameters are as aforementioned. In response, the network can provide the UE with a message that indicates the power domain parameters for PRACH configuration to apply.

In one example, SSBs are associated with ROs. The number of SSBs per RO,

$${N}_{R O}^{S S B} ,$$

wherein

$${N}_{R O}^{S S B} ∈ \{ 1 / 8 , 1 / 4 , 1 / 2 , 1 , 2 , 4 , 8 , 16 \} .$$

### If

$${N}_{R O}^{SSB} < 1 ,$$

multiple ROs are associated with the same SSB, wherein the number of consecutive ROs associated with an SSB is

$$1 / {N}_{R O}^{S S B} .$$

### If

$${N}_{R O}^{SSB} > 1 ,$$

multiple SSBs are associated with the same RO, wherein SSB n is associated with R preambles in an RO associated with SSB n that start from preamble

$$n \cdot {N}_{p r e a m b l e} / {N}_{R O}^{SSB} ,$$

where N_{preamble} is the total number of preambles in the RO. In one example, N_{preamble}=64.

In one example, SSBs are associated with ROs starting from frame 0, the mapping order of SSBs to ROs are in the following order:
First, in increasing order of preambles in RO, e.g., when

$${N}_{R O}^{SSB} > 1 ,$$

and multiple SSBs are mapped to the same RO.
Second, in increasing order of RO frequency, when ROs are frequency division multiplexed.
Third, in increasing order of ROs in a RACH slots
Fourth, in increasing order of RACH slots

The association period is the smallest period from Table 1 (below), such that each SSB of the active SSBs

$${N}_{T x}^{S S B}$$

is mapped to an RO at least once.

$${N}_{T x}^{S S B}$$

can be configured to the UE in SIB signaling (e.g., ssb-PositionbInBurst in SIB1) or by RRC signaling (e.g., ssb-PositionbInBurst in ServingCellConfigCommon or in SSB-MTC-AdditionalPCI or in LTM-SSB-Config). In one example, any leftover ROs after an integer number of mappings of SSBs to RO, are left unused. Association pattern period includes one or more association periods, so that a pattern between ROs and SSBs repeats every 160 ms.

TABLE 1

| PRACH configuration | Association period as number of |
|---|---|
| Period (msec) | PRACH configuration period |
| 10 | {1, 2, 4, 8, 16} |
| 20 | {1, 2, 4, 8} |
| 40 | {1, 2, 4} |
| 80 | {1, 2} |
| 160 | {1} |

In one example, the SSB-RO association pattern changes as result of a change in the following parameters:
Number of active SSBs,

$${N}_{T x}^{S S B} .$$

In one example, a list of SSBs from the active SSBs is provided to the UE, and the association of SSBs to ROs is based on the list provided. In example, the list is provided as a bitmap over the active SSBs, e.g., a value of 1 in a bit of the bitmap corresponding to an SSB indicates that the SSB is associated to an RO, and a value of 0 in the bit of the bitmap corresponding to the SSB indicates that the SSB is not associated (e.g., SSB is skipped) to an RO.
Number of SSBs per RO,

$${N}_{R O}^{S S B} .$$

In one example, a UE can be signaled a message that indicates the number of SSBs per RO to apply for new PRACH configuration.
Number of FDMed ROs, e.g., provided by msg1-FDM or msgA-RO-FDM or similar parameters in 6G. The update of the number of FDMed ROs can be as aforementioned.
Number of time domain ROs per RACH slot. In one example, the number of time domain ROs per RACH slot is explicitly configured. In one example, the number of time domain ROs per RACH slot is determined by a configuration parameter such as prach-ConfigurationIndex or similar parameter in 6G. The update of the number of time domain ROs in a slot can be as aforementioned.
Number of RACH slots per PRACH configuration period. In one example, the number of RACH slots per PRACH configuration period is explicitly configured. In one example, the number of RACH slots per PRACH configuration period is determined based on the number of RACH slots per subframe or per 60 kHz slot. In one example, the number of RACH slots per PRACH configuration period is determined based on the number of subframes or the number of 60 kHz slots per frames. In one example, the number of RACH slots per PRACH configuration period is determined by a configuration parameter such as prach-ConfigurationIndex or similar parameter in 6G. The update of the number of RACH slots can be as aforementioned.
Number of RACH subframes or 60 KHz slots per PRACH configuration period. In one example, the number of RACH subframes or 60 kHz slots per PRACH configuration period is explicitly configured. In one example, the number of RACH subframes or 60 kHz slots per PRACH configuration period is determined by a configuration parameter such as prach-ConfigurationIndex or similar parameter in 6G. The update of the number of RACH subframes or 60 kHz slots can be as aforementioned.

In one example, SSBs are divided into SSB groups. The number of SSBs is

$${N}_{Tx}^{SSB} .$$

The number of SSB groups is

$${N}_{Grp}^{SSB} .$$

In one example, if the number of SSBs per SSB group is the same for all SSB groups, the number of SSBs per SSB group is given by

$${N}_{Tx}^{SSB} / {N}_{GrP}^{SSB} .$$

In another example, if

$${N}_{Tx}^{SSB}$$

is not an integer multiple of

$${N}_{Grp}^{SSB} ,$$

the number of SSBs per SSB group is

$$⌈ {N}_{Tx}^{SSB} / {N}_{Grp}^{SSB} ⌉$$

for

$${N}_{Tx}^{SSB} \% {N}_{Grp}^{SSB}$$

SSB groups, and the number of SSBs per SSB group is

$$⌊ {N}_{Tx}^{SSB} / {N}_{Grp}^{SSB} ⌋$$

for the remaining SSB groups (E.g., for

$${N}_{Grp}^{SSB} - ( {N}_{Tx}^{SSB} \% {N}_{Grp}^{SSB} )$$

SSB groups). Wherein, % is the modulo operator, where x % N equals the remainder from the division of x by N.

In one example,

$${N}_{RO}^{SSB - Grp}$$

is the number of SSB groups associated with or mapped to an RO. If

$${N}_{RO}^{SSB - Grp} < 1 ,$$

multiple ROs are associated with the same SSB group, wherein the number of consecutive ROs associated with an SSB group is

$$1 / {N}_{RO}^{SSB - Grp} .$$

### If

$${N}_{RO}^{SSB - Grp} > 1 ,$$

multiple SSB groups are associated with the same RO, wherein SSB group m is associated with R preambles in an RO associated with SSB group m that start from preamble

$$m \cdot {N}_{preamble} / {N}_{RO}^{SSB - Grp} ,$$

where N_{preamble} is the total number of preambles in the RO. In one example, N_{preamble}=64. SSBs of a SSB group are associated with the same set of preambles.

In one example, a UE can be signaled a message that indicates the number of SSB groups to apply for a new PRACH configuration. In one example, a UE can be signaled a message that indicates the number SSBs per SSB group to apply for a new PRACH configuration. In one example, a UE can be signaled a message that indicates the number of SSB groups per RO to apply for new PRACH configuration.

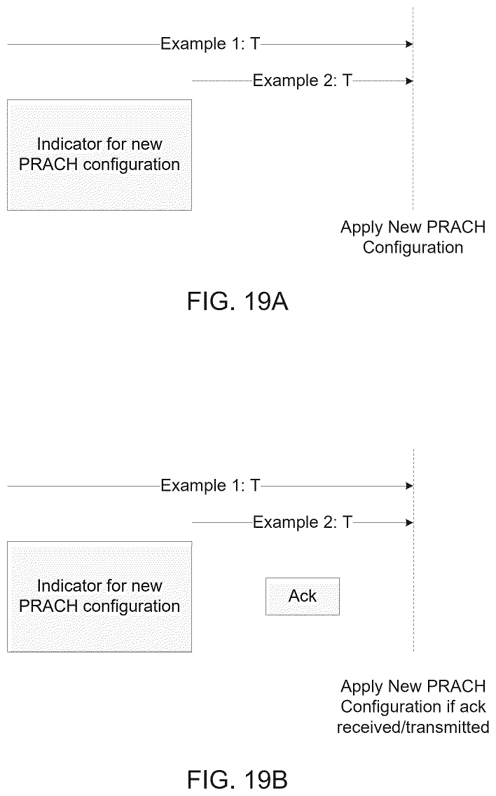

FIG. 17 illustrates an example of an RO according to embodiments of the present disclosure. More particularly, FIG. 17 illustrates an RO with N_{preamble}=K preambles. For example, the RO can be configured by BS 102 of FIG. 1. This example is for illustration only and other embodiments can be used without departing from the scope of the present disclosure.

In FIG. 17, the RO is associated with

$${N}_{RO}^{SSB - Grp} = M$$

SSB groups. Each SSB group has N SSBs, and is associated with R preambles. The association of preambles to SSB groups and SSBs is illustrated in FIG. 17. The association of SSB groups and SSBs to preambles is according to the following:
The first SSB group (SSB group 0) is associated with preamble set 0, wherein:
   SSB group 0 includes SSBs: 0, 1, . . . , N−1
   Preamble set 0 includes preambles: 0, 1, . . . , R−1
. . .
The (m+1)th SSB group (SSB group m) is associated with preamble set m, wherein:
   SSB group m includes SSBs: m*N, m*N+1, . . . , m*N+N−1
   Preamble set m includes preambles: m*K/M, m*K/M+1, . . . , m*K/M+R−1
. . .
The Mth SSB group (SSB group M−1) is associated with preamble set M−1, wherein:
   SSB group M−1 includes SSBs: (M−1)*N, (M−1)*N+1, . . . , (M−1)*N+N−1
Preamble set M−1 includes preambles: (M−1)*K/M, (M−1)*K/M+1, . . . , (M−1)*K/M+R−1

In one example, the UE can be indicated with a parameter, L that indicates the number of times an SSB is associated with an RO in an association period. After the UE associates an SSB with an RO L times in an association period, the remaining ROs of the association period are not used (not mapped to SSBs). In one example, the UE can be indicated with a parameter, L that indicates the number of times an SSB is associated with an RO in an association pattern period. After the UE associates an SSB with an RO L times in an association pattern period, the remaining ROs of the association pattern period are not used (not mapped to SSBs).

In one example, the UE can be provided with a message that indicates parameters for SSB-RO association for PRACH configuration to apply. In one example, the message is provided by SIB or RRC signal. In one example, the message is MAC CE is L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example, the UE can transmit an UL signal, e.g., using PUCCH or PUSCH or PRACH, and provide information about requested or preferred SSB-RO association for PRACH configuration, e.g., based on the type of services or the type of UE. The SSB-RO association parameters are as aforementioned. In response, the network can provide the UE with a message that indicates the SSB-RO association parameters for PRACH configuration to apply.

Other parameters for PRACH configuration can include:
preamble TransMax
   Range: {3, 4, 5, 6, 7, 8, 10, 20, 50, 100, 200}
   In one example, a UE can be signaled a message that indicates the preambleTransMax to apply for new PRACH configuration.
ra-ResponseWindow
   Range: {1, 2, 4, 8, 10, 20, 40, 80} slots
   In one example, a UE can be signaled a message that indicates the ra-ResponseWindow to apply for new PRACH configuration.
totalNumberOfRA-Preambles
   Range: 0 . . . 63
In one example, a UE can be signaled a message that indicates the totalNumberOfRA-Preambles to apply for new PRACH configuration.
RA contention resolution timer
   Range: {8, 16, 24, 32, 40, 48, 56, 64} subframes
   In one example, a UE can be signaled a message that indicates the “RA contention resolution timer” to apply for new PRACH configuration.

In one example, the UE can be provided with a message that indicates other parameters for PRACH configuration to apply. In one example, the message is provided by SIB or RRC signaling. In one example, the message is MAC CE is L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example, the UE can transmit an UL signal, e.g., using PUCCH or PUSCH or PRACH, and provide information about requested or preferred other parameters for PRACH configuration, e.g., as previously described and based on the type of services or the type of UE. The other parameters are as aforementioned. In response, the network can provide the UE with a message that indicates the other parameters for PRACH configuration to apply.

In one example, a UE is configured with multiple, e.g., N, configurations (or profiles) for PRACH. In one example, the N configurations (or profiles) are provided by SIB signaling (e.g., SIB1 or other SIB). In one example, the N configurations (or profiles) are provided by RRC signaling. In one example, the N configurations (or profiles) are provided by multiple SIBs, for example, a first configuration (or profile) (e.g., a default profile) is provided by a first SIB, e.g., SIB1, and the remaining configurations (or profiles) (e.g., N−1 configurations or profiles) are provided by a second SIB, e.g., SIBx or on-demand SIB (OD-SIB). In one example, the N configurations (or profiles) are provided by multiple SIB and RRC signaling, for example, a first configuration (or profile) (e.g., a default profile) is provided by a SIB, e.g., SIB1, and the remaining configurations (or profiles) (e.g., N−1 configurations or profiles) are provided by a RRC. In one example, each configuration or profile is associated with an index, e.g., an index from 0 to N−1.

In one example, the UE can transmit an UL signal, e.g., using PUCCH or PUSCH or PRACH, and provide information about requested or preferred PRACH configuration profile, e.g., as previously described and based on the type of services or the type of UE. In one example, UL signal includes an index of a profile requested or preferred by the UE. In response, the network can provide the UE with a message that indicates the PRACH configuration profile to apply.

In one example, a UE is signaled a message with a configuration or a profile or to use, e.g., by signaling the associated index of the configuration or profile. In one example, the message is provided by SIB or RRC signal. In one example, the message is provided by MAC CE or L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example when a UE is not signaled a message with a configuration or profile index, the UE uses a default configuration for PRACH. In one example, the index of the default configuration or profile is defined in the system specifications. In one example, the index of the default configuration or profile is index 0. In one example, the default configuration or profile is configured by a first SIB (e.g., SIB0), while the remaining configuration or profiles are configured by second SIB, e.g., SIBx or OD-SIB. In one example, the default configuration or profile is configured by a SIB (e.g., SIB0), while the remaining configuration or profiles are configured by RRC. In one example, the configuration information indicates the default profile. In one example, each configuration or profile includes a flag, and the flag indicates whether the configuration or profile is a default configuration or profile or not.

In one example, for a PRACH configuration parameter p a UE is configured with multiple, e.g., Nₚ, values. In one example, the Nₚ values are provided by SIB signaling (e.g., SIB1 or other SIB). In one example, the No values are provided by RRC signaling. In one example, the Nₚ values are provided by multiple SIBs, for example, a first value (e.g., a default configuration) is provided by a first SIB, e.g., SIB1, and the remaining values of the parameter (e.g., Nₚ−1 values) are provided by a second SIB, e.g., SIBx or OD-SIB. In one example, the Nₚ values are provided by multiple SIB and RRC signaling, for example, a first value (e.g., a default configuration) (e.g., a default configuration) is provided by a SIB, e.g., SIB1, and the remaining values of the parameter (e.g., Nₚ−1 values) are provided by a RRC. In one example, each value of parameter p is associated with an index, e.g., an index from 0 to Nₚ−1. In one example, the value, Ng is the same for PRACH configuration parameters that can be configured with multiple values. In one example, the value, Nₚ can be different for PRACH configuration parameters that can be configured with multiple values. In one example, Nₚ=1 for PRACH configuration parameters that can have a same value across different PRACH configurations or profiles.

In one example, the UE can transmit an UL signal, e.g., using PUCCH or PUSCH or PRACH, and provide information about requested or preferred PRACH configuration parameter, e.g., as previously described and based on the type of services or the type of UE. In one example, for configuration parameter p, the UL signal includes an index of a value of the configuration parameter requested or preferred by the UE, e.g., value nₚ with range 0, 1, . . . , Nₚ−1. In response, the network can provide the UE with a message that indicates the PRACH configuration parameter to apply.

In one example, a UE is signaled a message with a value index(es) for one or more parameters, e.g., by signaling one or more associated indexes of values of parameters. In one example, the message is provided by SIB or RRC signal. In one example, the message is provided by MAC CE or L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example when a UE is not signaled a message with a value index for a parameter, the UE uses a default configuration for the corresponding parameter. In one example, the index of the default value is defined in the system specifications. In one example, the index of the default value is index 0. In one example, the default value of a parameter is configured by a first SIB (e.g., SIB0), while the remaining values of the parameter are configured by second SIB, e.g., SIBx or OD-SIB. In one example, the default value of a parameter is configured by a SIB (e.g., SIB0), while the remaining values of the parameter are configured by RRC. In one example, the configuration information indicates the default value. In one example, for a parameter a field can indicate which value is the default value.

To illustrate the above, by way of example, consider a PRACH configuration parameter “msg1-FDM”. This parameter determines the number of PRACH transmission occasions FDMed in one time instance. In one example, “msg1-FDM” can be configured with a first value (index 0) of Four and a second value (index 1) of Two. In one example, the first value (e.g., index 0) is default value, when a UE is not provided any other indication, the UE uses the default value. In one example, the UE is configured the index of the default configuration, when a UE is not provided any other indication, the UE uses the default value based on the index of the default configuration. In one example, the index of the default configuration is defined in the system specifications, when a UE is not provided any other indication, the UE uses the default value. In one example, the UE can be provided with a message that indicates the index of a configuration to use. In one example, the message is provided by SIB or RRC signal. In one example, the message is MAC CE or L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message. In one example, the UE can transmit an UL signal, e.g., using PUCCH or PUSCH or PRACH, and provide information about requested or preferred PRACH configuration for msg1-FDM, e.g., as previously described and based on the type of services or the type of UE. For example, a UE with small maximum bandwidth capability UE can indicate index 1 for Two FDMed RO occasions. In response, the network can provide the UE with a message that indicates the PRACH configuration for msg1-FDM to apply.

In one example, a UE is signaled a message with value(es) for one or more parameters. In one example, the message is provided by SIB or RRC signal. In one example, the message is provided by MAC CE or L1 control (e.g., DCI Format or sequence-based). In one example, the message is transmitted or addressed to all UEs in the cell. In one example, the message is transmitted (or addressed to) a group of UEs, e.g., based on a group common RNTI used to scramble the CRC of a DCI Format (1) scheduling the message, or (2) that contains the message. In one example, the signal is transmitted (or addressed to) one UE (e.g., UE specific), e.g., based on a UE specific RNTI used to scramble the CRC of a DCI Format (1) scheduling the message, or (2) that contains the message.

In one example, the UE can transmit an UL signal, e.g., using PUCCH or PUSCH or PRACH, and provide information about requested or preferred value(es) of one or more parameters of a PRACH configuration, e.g., as previously described and based on the type of services or the type of UE. In response, the network can provide the UE with a message that indicates one or more parameters of a PRACH configuration to apply.

In one example when a UE is not signaled a message with a value for a parameter, the UE uses a default configuration for the corresponding parameter. In one example, the default value is defined in the system specifications. In one example, the default value of a parameter is configured by SIB (e.g., SIB0), e.g., based on the PRACH configuration in SIB. In one example, the default value of a parameter is configured by RRC, e.g., based on the PRACH configuration in RRC.

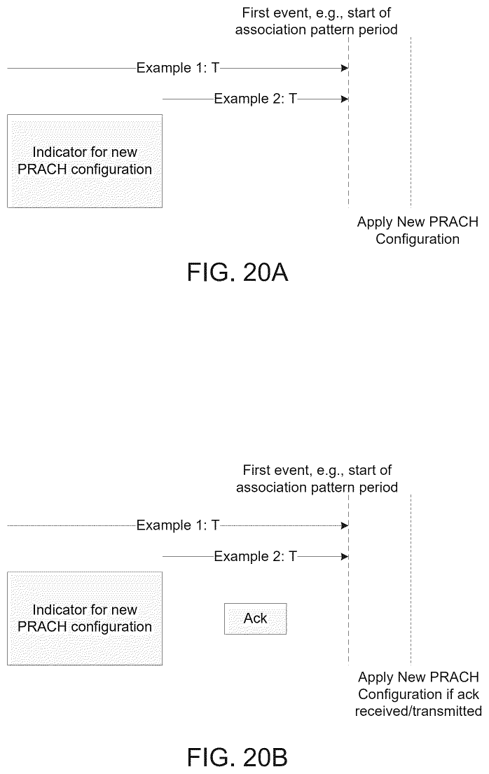

FIGS. 18A and 18B illustrate example methods 1800 and 1850 performed in a wireless communication system according to embodiments of the present disclosure. For example, the methods 1800 and 1850 can be performed by any of the UEs 111-116 and BS 102 of FIG. 1. The methods 1800 and 1850 are for illustration only and other embodiments can be used without departing from the scope of the present disclosure.

As illustrated in FIG. 18A, in one example, the method 1800 starts with the UE transmitting an UL signal or channel, and the UL signal or channel includes an indication for a preferred PRACH configuration profile and/or preferred PRACH configuration parameter(s) (1805). In one example, the UE determines the preferred PRACH configuration profile and/or preferred PRACH configuration parameter(s) based on the UE type or based on a type of service on the UE. For example, different sets of PRACH configuration parameters can be configured to different UE types. In one example, the network, in response to the UL signal or channel determines a new PRACH configuration profile to activate/apply or a new PRACH configuration parameter(s) to activate/apply. The network transmits a DL signal and/or channel that includes the PRACH configuration profile and/or PRACH configuration parameters to be activated (1810). In one example, after the DL channel or signal the indicated PRACH configuration profile and/or PRACH configuration parameters are activated as described herein (1815).

As illustrated in FIG. 18B, in one example, the method 1850 starts with the network (e.g., BS) determining a new PRACH configuration profile to activate/apply or a new PRACH configuration parameter(s) to activate/apply. In one example, the network determines the preferred PRACH configuration profile and/or preferred PRACH configuration parameter(s) based on activated or configured BWP or based on energy saving parameters or mode of network or BS. The network transmits a DL signal and/or channel that includes the PRACH configuration profile and/or PRACH configuration parameters to activate (1855). In one example, the indicated PRACH configuration profile and/or PRACH configuration parameters are activated as described herein (1860).

As aforementioned, a message providing the PRACH configuration, or a parameter(s) of the PRACH configuration to apply can be SIB or RRC or MAC CE or L1 control (e.g., DCI Format or sequence-base). In one example, the message is acknowledged by UE and the acknowledgment is transmitted in an UL channel (e.g., PUCCH or PUCCH or PRACH). In one example, the message is not acknowledged by UE. In one example, message with the new PRACH configuration is transmitted one time. In one example, the message with the new PRACH configuration is repeated M times.

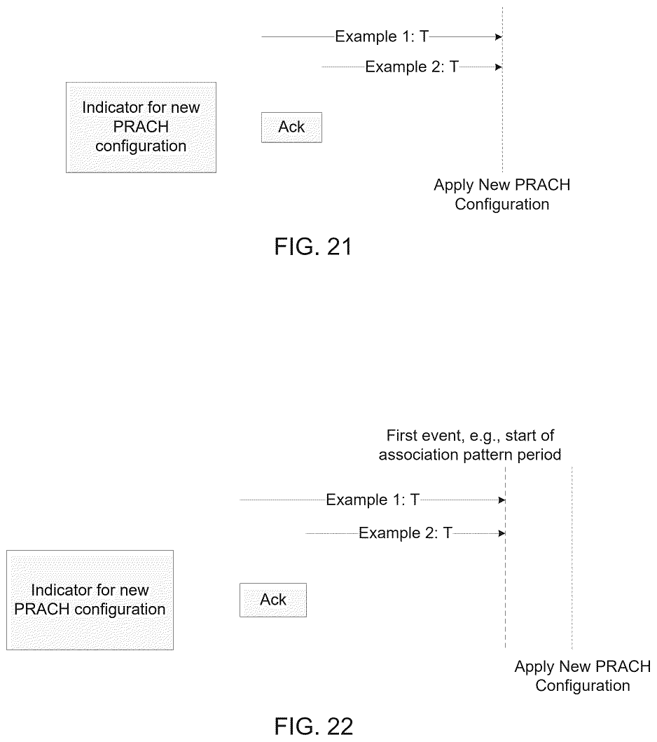

FIGS. 19A-22 illustrate timing examples for applying a new PRACH configuration upon indication according to embodiments of the present disclosure. For example, the timing can be implemented by any of the UEs 111-116 of FIG. 1. The examples are for illustration only and other embodiments can be used without departing from the scope of the present disclosure.

As illustrated in FIG. 19A, in one example, after a time T from the message providing the PRACH configuration, or a parameter(s) of the PRACH configuration, the PRACH configuration or the parameter(s) of the PRACH configurations are applied. In one example, T is measured from the start (e.g., first symbol) of the channel or slot carrying the message. In one example, T is measured from the end (e.g., last symbol) of the channel or slot carrying the message. In one example, T can be configured or updated by SIB or RRC or MAC CE or L1 control (e.g., DCI Format or sequence-based).

As illustrated in FIG. 19B, in one example, after a time T from the message providing the PRACH configuration, or a parameter(s) of the PRACH configuration, the PRACH configuration or the parameter(s) of the PRACH configurations are applied, when an acknowledgement (e.g., positive acknowledgement) is transmitted in an UL channel in response to the message. In one example, T is measured from the start (e.g., first symbol) of the channel or slot carrying the message. In one example, T is measured from the end (e.g., last symbol) of the channel or slot carrying the message. In one example, T can be configured or updated by SIB or RRC or MAC CE or L1 control (e.g., DCI Format or sequence-based).

As illustrated in FIG. 20A, in one example, starting from a first event occurring at or after a time T from the message providing the PRACH configuration, or a parameter(s) of the PRACH configuration, the PRACH configuration or the parameter(s) of the PRACH configurations are applied. In one example, T is measured from the start (e.g., first symbol) of the channel or slot carrying the message. In one example, T is measured from the end (e.g., last symbol) of the channel or slot carrying the message. In one example, T can be configured or updated by SIB or RRC or MAC CE or L1 control (e.g., DCI Format or sequence-based). In one example, an event can be a start of symbol. In one example, an event can be a start of a slot. In one example, an event can be a start of a sub-frame. In one example, an event can be a start of a frame. In one example, an event can be a start of a frame with system frame number (SFN) % 16=0. In one example, an event can be a start of a frame with system frame number (SFN) % N=0, where N can be defined in the system specification or provided by network configuration. In one example, an event can be a start of a frame, with SFN=0. In one example, an event can be a start of a PRACH configuration period. In one example, an event can be a start of an association period. In one example, an event can be a start of an association pattern period.

As illustrated in FIG. 20B, in one example, starting from a first event occurring at or after a time T from the message providing the PRACH configuration, or a parameter(s) of the PRACH configuration, the PRACH configuration or the parameter(s) of the PRACH configurations are applied, when an acknowledgement (e.g., positive acknowledgement) is transmitted in an UL channel in response to the message. In one example, T is measured from the start (e.g., first symbol) of the channel or slot carrying the message. In one example, T is measured from the end (e.g., last symbol) of the channel or slot carrying the message. In one example, T can be configured or updated by SIB or RRC or MAC CE or L1 control (e.g., DCI Format or sequence-based). In one example, an event can be a start of symbol. In one example, an event can be a start of a slot. In one example, an event can be a start of a sub-frame. In one example, an event can be a start of a frame. In one example, an event can be a start of a frame with system frame number (SFN) % 16=0. In one example, an event can be a start of a frame with system frame number (SFN) % N=0, where N can be defined in the system specification or provided by network configuration. In one example, an event can be a start of a frame, with SFN=0. In one example, an event can be a start of a PRACH configuration period. In one example, an event can be a start of an association period. In one example, an event can be a start of an association pattern period.

As illustrated in FIG. 21, in one example, after a time T from an UL channel carrying an acknowledgement (e.g., positive acknowledgement) to the message providing the PRACH configuration, or a parameter(s) of the PRACH configuration, the PRACH configuration or the parameter(s) of the PRACH configurations are applied. In one example, T is measured from the start (e.g., first symbol) of the UL channel or slot. In one example, T is measured from the end (e.g., last symbol) of the UL channel or slot. In one example, T can be configured or updated by SIB or RRC or MAC CE or L1 control (e.g., DCI Format or sequence-based).

As illustrated in FIG. 22, in one example, starting from a first event occurring at or after a time T from an UL channel carrying an acknowledgement (e.g., positive acknowledgement) to the message providing the PRACH configuration, or a parameter(s) of the PRACH configuration, the PRACH configuration or the parameter(s) of the PRACH configurations are applied. In one example, T is measured from the start (e.g., first symbol) of the UL channel or slot. In one example, T is measured from the end (e.g., last symbol) of the UL channel or slot. In one example, T can be configured or updated by SIB or RRC or MAC CE or L1 control (e.g., DCI Format or sequence-based). In one example, an event can be a start of symbol. In one example, an event can be a start of a slot. In one example, an event can be a start of a sub-frame. In one example, an event can be a start of a frame. In one example, an event can be a start of a frame with system frame number (SFN) % 16-0. In one example, an event can be a start of a frame, with SFN=0. In one example, an event can be a start of a PRACH configuration period. In one example, an event can be a start of an association period. In one example, an event can be a start of an association pattern period.

In one example, when a UE does not receive a message updating a PRACH configuration or a parameter of a PRACH configuration after a time Td from the start or end of last message or slot of last message, the UE reverts to the default PRACH configuration or the default PRACH configuration of a parameter of the PRACH configuration. In one example, Td can be configured or updated by SIB and/or RRC and/or MAC CE and/or L1 control (e.g., DCI Format or sequence-based).

In the present disclosure, an on-demand PRACH triggered or activated by the gNB is provided.

The configuration of PRACH resources (e.g., PRACH Occasions) is a tradeoff between energy consumption and overhead versus reduced latency and probability of collision. Having a number of ROs that is larger than necessary can lead to high energy consumption at the gNB for monitoring the ROs to detect PRACH preambles and to high overhead due to the resources used by the ROs. However, the more the ROs, the less the latency and the less the probability of collisions. To control the tradeoff between energy consumption/overhead and latency/probability of collision, while addressing current traffic characteristics in a network, on-demand ROs can be triggered by the network/gNB when PRACH is transmitted.

In one example, a PDCCH order from the network to the UE triggers the transmissions of a PRACH from the UE. In one example, a PDCCH order from the network to the UE triggers the activation of ROs. In one example, message from the network to the UE triggers the activation of ROs, wherein the message can SIB and/or RRC and/or MAC CE and/or L1 control (e.g., DCI Format or sequence-based). The L1 control can be provided by UE-group specific or cell-specific signaling or by UE-specific signaling, e.g., a DCI format with CRC scrambled by RNTI and the RNTI is UE-group common or cell common (for UEs in a cell) or UE-specific, respectively.

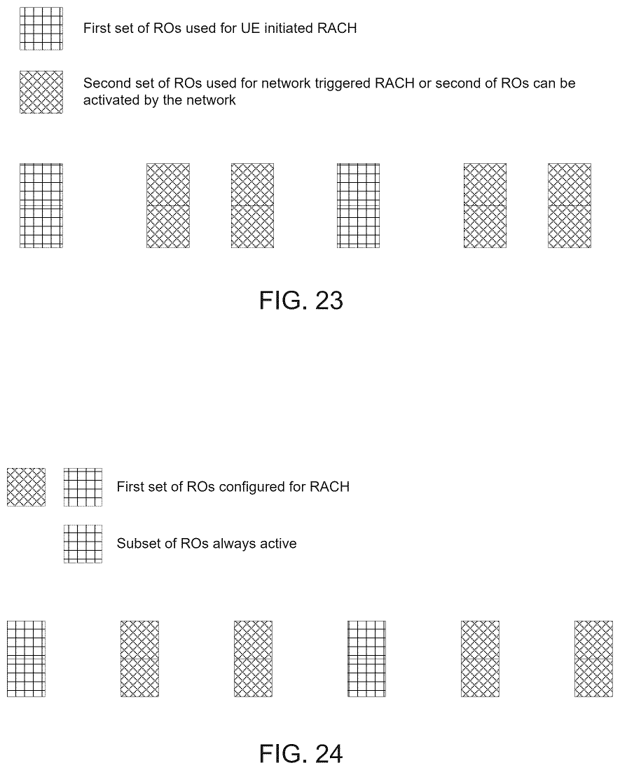

FIG. 23 illustrates examples of a first and second set of ROs according to embodiments of the present disclosure. For example, the first and second set of ROs can be configured by BS 102 of FIG. 1. These examples are for illustration only and other embodiments can be used without departing from the scope of the present disclosure.

As illustrated in FIG. 23, in one example, a first set of ROs is configured for UE initiated PRACH transmissions. Further, a second set of ROs is configured for PRACH transmissions triggered by the network (e.g., using a PDCCH order or message activating ROs). In FIG. 23, in one example, a first set of ROs is configured for UE initiated PRACH transmissions, the network can monitor those ROs to possibly detect UE initiated RACH transmissions, and a second set of ROs is configured for network triggered PRACH transmissions, and the network monitors those ROs when the network triggers a PRACH transmission from the UE. In one example, a first set of ROs is always active and a second set of ROs can be conditionally activated based on signaling from the network. If there are no PRACH transmissions triggered by the network, or if the second set of ROs is not activated by the network, the resources allocated to the second set of ROs, can be used for other purposes (e.g., other UL transmissions and/or DL transmissions and/or SL transmissions). The association of the first set of ROs with SSBs or CSI-RS is done independently of the association of the second set of ROs. The association of the first set of ROs with SSBs can follow the aforementioned rules within the first set of ROs. The association of the second set of ROs follows the aforementioned rules within the second set of ROs. In one example, if the network does not trigger a PRACH transmission in an RO of the second set, or if the second set of ROs is not activated by the network, the RO is not monitored by the network, and the UE is not expected to transmit in the RO. In one example, if the network does not trigger a PRACH transmission in an RO of the second set, or if the second set of ROs is not activated by the network, the RO can be used for other transmissions.

In one example, two sets of ROs (a first set of ROs and a second set of ROs) are configured by the network for PRACH transmissions, e.g., the two sets of ROs can be used for network triggered RACH transmissions. In one example, the network can signal to a UE whether to use the ROs of the first set or the ROs of the second set. In one example, the network can signal to the UE whether to use the ROs of the first set or the ROs of the second set or the ROs of both the first set and the ROs of the second set. In one example, the signaling of which set(s) of ROs to use for network triggered PRACH transmissions can be in the channel/signal triggering the PRACH transmission (e.g., in a PDCCH order). In one example, the signaling of which set(s) of ROs to use for network triggered PRACH transmissions can be in a channel/signal separate from the channel/signal triggering the PRACH transmission, e.g., SIB, or RRC or MAC CE or L1 control (e.g., DCI Format or sequence-based). The L1 control can be provided by UE-group specific or cell-specific signaling or by UE-specific signaling, e.g., a DCI format with CRC scrambled by RNTI and the RNTI is UE-group common or cell common (for UEs in a cell) or UE-specific respectively. In one example, when signaling is in a separate channel/signal, the indication of which set(s) of ROs to use is applied after a time T, or starting at a first time-unit that starts at or after a time T. In one example, time T is from start or end of the channel/signal or slot signaling which set(s) of ROs to use. In one example, time T is from start or end of the channel/signal or slot with the acknowledgment of the signaling of which set(s) of ROs to use. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.

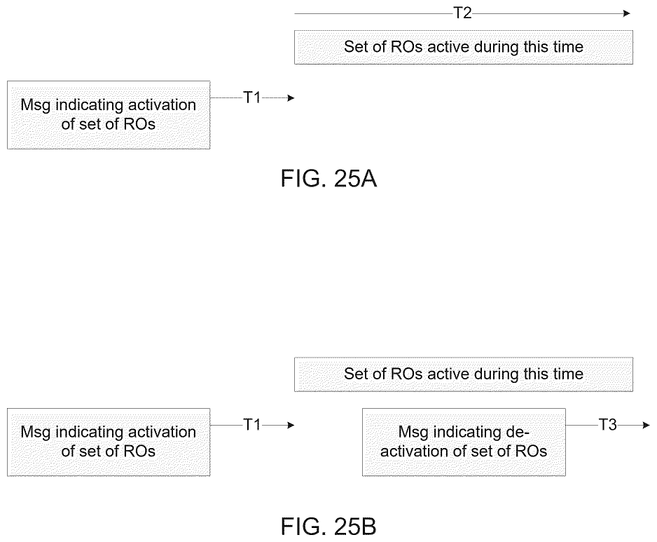

FIG. 24 illustrates alternative examples of a first and second set of ROs according to embodiments of the present disclosure. For example, the first and second set of ROs can be configured by BS 102 of FIG. 1. These examples are for illustration only and other embodiments can be used without departing from the scope of the present disclosure.

As illustrated in FIG. 24, in one example, a first set of ROs is configured for PRACH transmissions, which can include UE initiated PRACH transmissions as well as network triggered (e.g., using a PDCCH order) PRACH transmissions. In one example, a second set of ROs, which is a subset of the first set of ROs is used for UE initiated PRACH transmissions. In one example, a first set of ROs is configured for PRACH transmissions, which can include UE initiated PRACH transmissions as well as network triggered (e.g., using a PDCCH order) PRACH transmissions. In one example, a second set of ROs, which is a subset of the first set of ROs is always active. In FIG. 24, a first set of ROs is configured for PRACH transmissions, which can include UE initiated PRACH transmissions as well as network triggered RACH transmissions. A second set of ROs, which is a subset of the first set ROs, is configured and is used for UE initiated PRACH transmissions, the ROs of the subset (second set) can also be used for network triggered PRACH transmissions. In one example, the subset of ROs is always active, and resources in the set but outside the subset can be activated, e.g., on-demand by the network. In on example, the ROs outside the subset (second set), but within the first set, are used for network triggered PRACH transmissions, but not used for UE initiated PRACH transmissions. If there is no PRACH transmission triggered by the network, the RO resources within the first set and outside of the subset (second set), can be used for other purposes (e.g., other UL transmissions and/or DL transmissions and/or SL transmissions). In one example, ROs association with SSBs is done according to the first set of ROs. In one example, within an association pattern period, each SSB is associated with an integer number of ROs (e.g., N₁) of the first set of ROs, and each SSB is associated with an integer number of ROs (e.g., N₂) of the second set of ROs, wherein N₂≤N₁. In one example, if the network does not trigger a PRACH transmission, an RO in the first set and outside the second set is not monitored by the network, and the UE is not expected to transmit in such RO. In one example, if the network does not trigger a PRACH transmission, an RO in the first set and outside the second set, can be used of other transmissions.

In one example, a first set of ROs is configured and a second set of ROs which is a subset of the first set of ROs is configured. In one example, the network can signal to a UE whether to use the ROs of the first set (including the ROs of the second set) or the ROs of the second set (excluding ROs in the first set that are not within the second set). In one example, the network can signal to the UE whether to use the ROs of the first set (including the ROs of the second set) or the ROs of the second set (excluding ROs in the first set that are not within the second set) or the ROs of the first excluding the ROs of the second set. In one example, the signaling of which set(s) of ROs to use for network triggered RACH transmissions can be in the channel/signal triggering the PRACH transmission (e.g., PDCCH order). In one example, the signaling of which set(s) of ROs to use for network triggered PRACH transmissions can be in a channel/signal separate from the channel/signal triggering the PRACH transmission, e.g., SIB, or RRC or MAC CE or L1 control (e.g., DCI Format or sequence-based). The L1 control can be provided by UE-group specific or cell-specific signaling or by UE-specific signaling, e.g., a DCI format with CRC scrambled by RNTI and the RNTI is UE-group common or cell common (for UEs in a cell) or UE-specific respectively. In one example, when signaling is in a separate channel/signal, the indication of which set(s) of ROs to use is applied after a time T, or starting at a first time-unit that starts at or after a time T. In one example, time T is from start or end of the channel/signal or slot signaling which set(s) of ROs to use. In one example, time T is from start or end of the channel/signal or slot with the acknowledgment of the signaling of which set(s) of ROs to use. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.

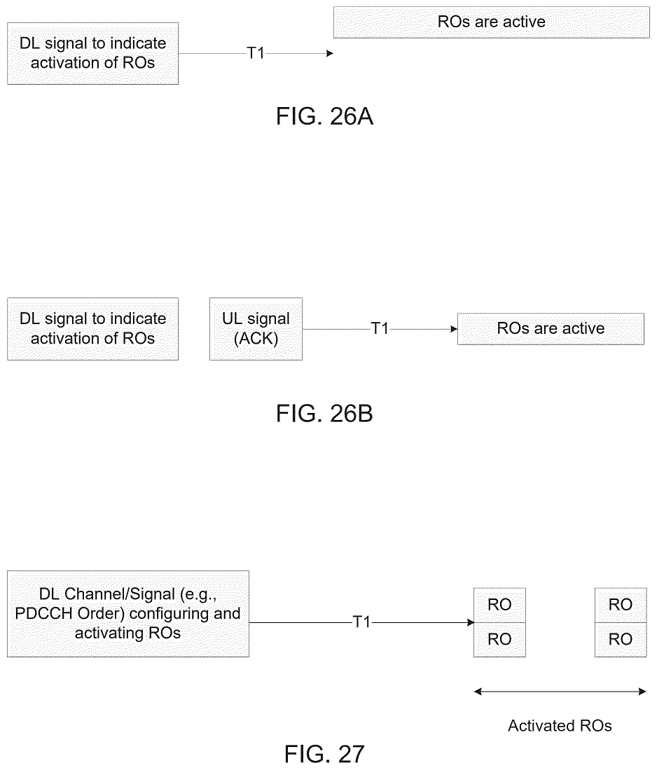

FIGS. 25A-27 illustrate examples of channel/signal indication for activating a set of ROs according to embodiments of the present disclosure. For example, the channel/signal indication can be implemented by BS 102 of FIG. 1. These examples are for illustration only and other embodiments can be used without departing from the scope of the present disclosure.

In one example, a UE is configured a first set of ROs for PRACH transmission and a second set of ROs for PRACH transmission. In one example, the first set of ROs for PRACH transmission is active after configuration. In one example, as illustrated in FIGS. 25A and 25B, a network transmits a channel/signal, to indicate the activation of the second set of ROs. In one example, the channel/signal activating (or indicating the activation of) the second set of ROs is SIB or RRC or MAC CE or L1 control (e.g., DCI Format or sequence-based). The L1 control can be provided by UE-group specific or cell-specific signaling or by UE-specific signaling, e.g., a DCI format with CRC scrambled by RNTI and the RNTI is UE-group common or cell common (for UEs in a cell) or UE-specific respectively. In one example, the channel/signal activating (or indicating the activation of) the second set of ROs is a PDCCH command or PDCCH order (e.g., triggering a RACH transmission). In one example, after a time T1 from the start or end of the channel/signal or slot of channel/signal that activates (or indicates the activation of) the ROs of the second set, the UE can transmit in an RO from the second set of configured ROs. In one example, after a time T1 from the start or end of the channel/signal or slot of channel/signal carrying the acknowledgment to the channel/signal activating (or indicating the activation of) the ROs of the second set, the UE can transmit in an RO from the second set of configured ROs. In one example, starting from a time-unit that starts at or after a time T1 from the start or end of the channel/signal or slot of channel/signal that activates (or indicating the activation of) the ROs of the second set, the UE can transmit in an RO from the second set of configured ROs. In one example, starting from a time-unit that starts at or after a time T1 from the start or end of the channel/signal or slot of channel/signal the acknowledgment to the channel/signal activating (or indicating the activation of) the ROs of the second set, the UE can transmit in an RO from the second set of configured ROs. In one example, the channel/signal carrying the acknowledgement is PUCCH or PUSCH carrying HARQ-ACK. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period. In one example, the UE transmits the UL channel with acknowledgment before achieving timing alignment with the target cell. In one example, the UL channel with acknowledgment is tolerant to timing miss-alignment. In one example, the UL channel with acknowledgment has a large cyclic prefix. In one example, the UL channel with acknowledgment is a PRACH. In one example, UE estimates and applies a time offset for the UL channel with acknowledgment.

In one example, the ROs activated in the second set can be the ROs associated with all SSBs or all CSI-RS. In one example, the ROs activated in the second set can be the ROs associated with one or more SSB or one or more CSI-RS, wherein the indexes of the one or more SSBs or the one or more CSI-RS are determined based on the signal activating (or indicating the activation of) the ROs of the second set, e.g., based on explicit indication in the signal of the SSB(s) or CSI-RS(s), for example the signal includes a list or a bitmap of SSBs or CSI-RSs, the ROs and/or preambles corresponding to these SSBs or CSI-RSs are activated, for example for a bit in the bitmap with value “1”, the corresponding SSB or CSI-RS is determined, and the corresponding/associated ROs and/or preambles are activated. Or based on implicit indication such as the timing or resources used for the signal, for example based on a configured mapping between the timing or resource of activation signal and one or more SSBs or CSI-RSs, the corresponding/associated ROs and/or preambles (to the SSBs or CSI-RSs) are activated.

In one example, the ROs of the second set remain activated until a PRACH preamble is received. In one example, the ROs of the second set remain active for a time T2 from the start or end of channel/signal or slot of channel/signal activating (or indicating the activation of) ROs of the second set. In one example, as illustrated in FIG. 25A, ROs remain active for a time T2 from the time of activation of ROs of the second set. In one example, as illustrated in FIG. 25B, the gNB/Network can transmit a channel/signal to deactivate (or indication the deactivation of) the ROs of the second set.

In one example, after a time T3 from the start or end of the channel/signal or slot of channel/signal that deactivates (or indicates the deactivation of) the ROs of the second set, the UE stops transmission of PRACH in an RO from the second set of configured ROs. In one example, after a time T3 from the start or end of the channel/signal or slot of channel/signal carrying the acknowledgment to the channel/signal deactivating (or indicating the deactivation of) the ROs of the second set, the UE stops transmission of PRACH in an RO from the second set of configured ROs. In one example, starting from a time-unit that starts at or after a time T3 from the start or end of the channel/signal or slot of channel/signal that deactivates (or indicating the deactivation of) the ROs of the second set, the UE stops transmission of PRACH in an RO from the second set of configured ROs. In one example, starting from a time-unit that starts at or after a time T3 from the start or end of the channel/signal or slot of channel/signal of the acknowledgment to the channel/signal deactivating (or indicating the deactivation of) the ROs of the second set, the UE stops transmission of PRACH in an RO from the second set of configured ROs. In one example, the channel/signal carrying the acknowledgement is PUCCH or PUSCH carrying HARQ-ACK. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.

In one example, the network receives multiple channels/signals from corresponding multiple UEs to request or activate ROs of the second set, the network activates the ROs of the second set, and transmits a channel/signal, as aforementioned, indicating the activation of the ROs of the second set, the ROs can remain active until the network receives corresponding channels/signals from each of the corresponding UEs to deactivate ROs of the second set, the network/gNB transmits a channel/signal, as aforementioned, indicating the deactivation of the ROs of the second set and hence the ROs of the second set are deactivated.

In a variant of the aforementioned examples, there are multiple second sets of ROs configured. One of the multiple second sets of ROs can be activated (or indicated as activated) by network/gNB. In one example, a set of the second sets is activated (or indicated as being activated) based on explicit indication in the signal activating (or indicating the activation of) ROs, e.g., based on signaling of an ID of one of the second sets. In one example, a set of the second sets is activated (or indicated as being activated) based on implicit indication in the signal activating or requesting ROs, e.g., based on the timing or resources used for the signal activating (or indicating the activation of) ROs, for example based on a configured mapping between the timing or resource of activation signal and an ID of a second set.

In a variant of the aforementioned examples, the first set of ROs is a subset of the second set of ROs. In a variant of the aforementioned examples, the second set of ROs is a superset of the first set of ROs.

In one example, the message triggering the PRACH transmission, can indicate the time frequency resources of the RO(s) to use for PRACH transmission. In one example, the message triggering the PRACH transmissions is a PDCCH order. In one example, the message triggering the PRACH transmission indicates the starting RB of the PRACH transmission. In one example, the message triggering the PRACH transmission indicates an index of an FDMed ROs, for example, if there are N FDMed ROs that are configured, the message can indicate one or a subset of the N FDMed ROs. In one example, the message triggering the PRACH transmission indicates the time domain resource PRACH transmission. In one example, the time domain resource is an offset from the start or the end of message or slot of message triggering the PRACH transmission. In one example, the time domain resource indicates a PRACH frame. In one example, the time domain resource indicates a PRACH sub-frame(s). In one example, the time domain resource indicates a PRACH slot(s). In one example, the time domain resource indicates a time domain RO(s) within a PRACH slot. In one example, the time domain resource indicates a starting symbol of an RO. In one example, the message triggering the PRACH transmission indicates RO(s) to use (e.g., frequency resource indicating frequency index of RO or starting RB, and time resource indicating offset (symbol/slot/subframe/frame) from triggering message) from triggering message, or indicating the time resource of RO (e.g., frame index/subframe index/slot index/TDRO index in slot/starting symbols)).

As illustrated in FIGS. 26A and 26B, in one example, a network/gNB can transmit a first signal to activate or indicate the activation of ROs. In one example, the first signal activating (or indicating the activation of) ROs is SIB or RRC or MAC CE or L1 control (e.g., DCI Format or sequence-based). The L1 control can be provided by UE-group specific or cell-specific signaling or by UE-specific signaling, e.g., a DCI format with CRC scrambled by RNTI and the RNTI is UE-group common or cell common (for UEs in a cell) or UE-specific respectively. In one example, the first signal activating (or indicating the activation of) ROs is PDCCH order (e.g., triggering a PRACH transmission). In one example, the first signal is a wake-up-signal (WUS) (e.g., sequence-based signal). In one example, the first signal is a low-power WUS (LP-WUS), wherein a LP-WUS is received by a low-power receiver. In one example, following the first signal the network activates a PRACH configuration relative to the first signal or slot of first signal, as illustrated in FIG. 26A. In one example, the UE transmits a second signal in response to the first signal (e.g., the second signal includes acknowledgment to first signal, e.g., second signal uses PUCCH or PUSCH). In one example, the second signal is a PRACH signal transmitted in the activate RO. In one example, the PRACH configuration activated is relative to second signal or slot of second signal, as illustrated in FIG. 25B. In one example, the PRACH configuration starts at frame boundary. In one example, the PRACH configuration at frame SFN % N=0. In one example, N is the PRACH configuration period. In one example, N is the association period. In one example, N is the association pattern period. In one example, N=16.

In one example, a first cell is a serving cell of a UE, and the UE is configured to receive a DL channel/signal from a second cell to activate a PRACH configuration (e.g., set of ROs and associated preambles). In one example, the second cell can be target cell for mobility (e.g., a target cell for L1/L2 triggered mobility (LTM)). In one example, the DL channel/signal is a PDCCH order triggering a PRACH transmission. In one example, the DL channel/signal is received in a common search space (CSS) set of the second cell. In a variant example, the DL channel/signal is received from the first cell, in a CCS set of the first set. In one example, the DL channel/signal is a sequence-based signal triggering a PRACH transmission.

In one example, a configuration can be preconfigured to the UE by the service provider for a cell, wherein the configuration includes receiving a DL channel/signal form the cell to activate a PRACH configuration (e.g., set of ROs and associated preambles). In one example, the DL channel/signal is a PDCCH order triggering a PRACH transmission. In one example, the DL channel/signal is received in a common search space (CSS) set of the cell. In one example, the DL channel/signal is a sequence-based signal triggering a PRACH transmission.

In one example, the PDCCH or sequence-based signal (triggering PRACH or activating or indicating PRACH configuration) order can include or indicate one or more of the following parameters for the transmission of PRACH. In a variant example, some of these parameters are configured by the SIB:
Time domain RO. In one example, the TDRO is determined based on a PRACH configuration index pointing a row in one of the tables 6.3.3.2-2, 6.3.3.2-3, and 6.3.3.2-4 of REF 1. In one example, the first TDRO that is active is after a time T1 from the start or end of the PDCCH order or sequence-based signal, e.g., as illustrated in FIG. 27. In one example, the first TRDO that is active starts at or after a time-unit starting T1 from the start or end of the PDCCH order or sequence-based signal or slot of such channel/signal. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.
   In one example, the RACH frame(s) is provided in the PDCCH order. In one example, the RACH subframe(s) is provided in the PDCCH order or sequence-based signal. In one example, the RACH 60 kHz slot(s) is provided in the PDCCH order or sequence-based signal. In one example, the RACH slot(s) is provided in the PDCCH order or sequence-based signal, wherein the slot is based on the SCS of preamble for short preamble formats, or the SCS 15 kHz for long preamble formats or SCS of the PDCCH order or sequence-based signal, or the SCS is provided by the PDCCH order or sequence-based signal.
   In one example, an offset is provided in the PDCCH order or sequence-based signal, wherein the offset is between the PDCCH order (start or end) or sequence-based signal or slot of such channel/signal and the TDRO (start or end). In one example, the offset is in symbols. In one example, the offset is slots (based on SCS of preamble for short preamble formats or 15 kHz for long preamble formats or based on SCS of PDCCH order). In one example, the offset is in 60 kHz slots. In one example, the offset is in sub-frames. In one example, the offset is in frames. In one example, the offset is in a combination of more than one of the aforementioned units. In one example, the time of the TDRO is determined by an offset in time-units, and an absolute value within the time unit. For example, the TDRO can be determined by an offset in subframes and slots and an RO(s) number with the slot.
   In one example, a periodicity is provided a time between ROs that can be used for PRACH transmission. In one example, the periodicity is in symbols. In one example, the periodicity is slots (based on SCS of preamble for short preamble formats or 15 kHz for long preamble formats or based on SCS of PDCCH order or sequence-based signal). In one example, the periodicity is in 60 kHz slots. In one example, the periodicity is in sub-frames. In one example, the periodicity is in frames. In one example, the periodicity is in a combination of more than one of the aforementioned units.
   In a variant example, the parameters to determine the TDROs, as aforementioned, are provided by the SIB (of the first cell or the second cell) or preconfigured in the UE. In a variant example, the parameters to determine the TDROs, as aforementioned, are provided by the PDCCH order or sequence-based signal. In a variant example, some of the parameters to determine the TDROs, as aforementioned, are provided by the PDCCH order or sequence-based signal and some of the parameters are provided by the SIB (of the first cell or the second cell) or preconfigured in the UE.
Frequency domain RO (FDRO). In one example, the FDRO is determined by a starting resource block (RB) index, and the starting RB index is provided in the PDCCH ordered or sequence-based signal. In one example, the starting RB index is relative to the start of an UL BWP, e.g., active UL BWP of first second or (initial) UL BWP of second cell or initial UL BWP part of first cell. In one example, the starting RB index is relative to the PDCCH order or sequence-based signal (start RB or end RB of PDCCH order or sequence-based signal). In one example, the starting RB index is relative to the start a carrier, e.g., start of a carrier of the first cell, or start of a carrier of the second cell. In one example, the starting RB index is relative to point A, e.g., point A of the first cell or point A of the second cell. In one example, a same carrier is used for the first cell and the second cell. In one example, a point A is used for the first cell and the second cell.
   In one example, FDRO is determined by an FDRO index, e.g., FDRO index(es) within the PRACH configuration of the first cell. In one example, a number of FDROs are provided by the PDCCH order or sequence-based signal, e.g., based start FDRO and the number of FDMed FDROs, in one example, the FDMed FDRs are consecutive.
   In a variant example, the parameters to determine the FDROs, as aforementioned, are provided by the SIB (of the first cell or the second cell) or preconfigured in the UE. In a variant example, the parameters to determine the FDROs, as aforementioned, are provided by the PDCCH order or sequence-based signal. In a variant example, some of the parameters to determine the FDROs, as aforementioned, are provided by the PDCCH order or sequence-based signal and some of the parameters are provided by the SIB (of the first cell or the second cell) or preconfigured in the UE.
Preamble format. In one example, a preamble format is determined based on a PRACH configuration index pointing a row in one of the tables 6.3.3.2-2, 6.3.3.2-3, and 6.3.3.2-4 of REF 1. In one example, the preamble format of the second cell is the same as the preamble format of the first cell. In a variant example, the preamble format, is provided by the SIB (of the first cell or the second cell) or preconfigured in the UE. In a variant example, the preamble format is provided by the PDCCH order or sequence-based signal.
Root sequence index. In one example, the root sequence index is provided in the PDCCH order or sequence-based signal. In a variant example, the root sequence index, is provided by the SIB (of the first cell or the second cell) or preconfigured in the UE.
Restricted set configuration. In one example, the restricted set configuration is provided in the PDCCH order or sequence-based signal. In one example, the restricted set configuration of the second cell is the same as the restricted set configuration of the first cell. In a variant example, the restrict set configuration, is provided by the SIB (of the first cell or the second cell) or preconfigured in the UE.
Zero Correlation Zone Configuration. In one example, the zero correlation zone configuration is provided in the PDCCH order or sequence-based signal. In one example, the zero correlation zone configuration of the second cell is the same as the zero correlation zone configuration of the first cell. In a variant example, the zero correlation zone configuration, is provided by the SIB (of the first cell or the second cell) or preconfigured in the UE.
Preamble Target Received Power. In one example, the preamble target received power is provided in the PDCCH order or sequence-based signal. In one example, the preamble target received power of the second cell is the same as the preamble target received power of the first cell. In a variant example, the preamble target received power, is provided by the SIB (of the first cell or the second cell) or preconfigured in the UE.
Power Ramping Step Size. In one example, the power ramping step size is provided in the PDCCH order or sequence-based signal. In one example, the power ramping step size of the second cell is the same as the power ramping step size of the first cell. In a variant example, the power ramping step size, is provided by the SIB (of the first cell or the second cell) or preconfigured in the UE.
rsrp-Threshold SSB. In one example, the rsrp-Threshold SSB is provided in the PDCCH order or sequence-based signal. In one example, the rsrp-Threshold SSB of the second cell is the same as the rsrp-Threshold SSB of the first cell. In a variant example, the rsrp-Threshold SSB, is provided by the SIB (of the first cell or the second cell) or preconfigured in the UE.
Number of SSBs per RO. In one example, the number of SSBs per RO is provided in the PDCCH order or sequence-based signal. In one example, the number of SSBs per RO of the second cell is the same as the Number of SSBs per RO of the first cell. In a variant example, the number of SSBs per RO, is provided by the SIB (of the first cell or the second cell) or preconfigured in the UE.
Random Access Preamble Index. In one example, the random access preamble index can indicate the index of the preamble within the RO used for preamble transmission. In one example, the random access preamble index can indicate the index of the preamble within the set of preambles allocated to the indicated SS/PBCH index with the RO used for preamble transmission. In one example, the random access preamble index is provided in the PDCCH order or sequence-based signal.
SS/PBCH index. In one example, this field indicates the SS/PBCH that shall be used to determine the RO for the PRACH transmission. In one example, this field indicates the SS/PBCH that shall be used to determine the RO and the set of preambles within the RO associated with SS/PBCH index, based on number of SSBs per RO, for the PRACH transmission. In one example, the SS/PBCH index is provided in the PDCCH order or sequence-based signal. In one example, a list of SS/PBCH indices corresponding to the activated ROs is provided in the PDCCH order or sequence-based signal or by the SIB (of the first cell or the second cell) or preconfigured in the UE.
PRACH Mask index. This field indicates the RO associated with the SS/PBCH indicated by “SS/PBCH index” for the PRACH transmission, according to Clause 5.1.1 of [8, REF 5] In one example, the PRACH Mask index is provided in the PDCCH order or sequence-based signal.
PRACH retransmission indicator. This field indicates whether the PRACH transmission is an initial transmission or a retransmission. In one example, in case of retransmission, the UE ramps the PRACH transmission power by the power ramping step size. In one example, the PRACH retransmission indicator is provided in the PDCCH order or sequence-based signal.

In one example, the PRACH configuration is activated after a time T1 from the DL channel/signal (e.g., PDCCH order or sequence-based signal) or slot of such channel/signal activating the PRACH configuration, e.g., ROs and associated preambles as aforementioned. In one example, the PRACH is active until a preamble is received by the network. In one example the PRACH configuration is active for a time T2 from the channel/signal (e.g., PDCCH order or sequence-based signal) or slot of such channel/signal activating the PRACH configuration, e.g., ROs and associated preambles, or from the time of activation of the PRACH configuration. In one example, PRACH configuration is active until the network transmits a DL channel/signal to deactivate the PRACH configuration (e.g., a time T2 after the start or end or slot of the deactivation message or starting at a time-unit that starts at or after a time T2 from the start or end or slot of the deactivation message, wherein the time-unit is as aforementioned). In this disclosure a time for slot can be a time the start of the slot or the end of the slot.

In the present disclosure, an on-demand PRACH triggered or activated by the UE is provided.

The configuration of PRACH resources (e.g., PRACH Occasions) is a tradeoff between energy consumption and overhead on one side and reduced latency and probability of collision on the other side. Having too many ROs, can lead to high energy consumption at the gNB by monitoring the ROs to detect PRACH preambles and can lead to high overhead due to the resources used by the ROs. However, the more, the ROs, the less the latency and the smaller the probability of collisions. To mitigate the tradeoff between energy consumption/overhead and latency/probability of collision, on-demand ROs can be triggered by the UE when PRACH is transmitted.

In one example, a UE can transmit a signal to request or activate ROs, for example when no ROs are activated on the cell where the UE camps on. In one example, the signal is a wake-up-signal (WUS), e.g., sequence-bases signal or RACH preamble. In one example, the signal is a low-power WUS (LP-WUS), wherein a LP-WUS is received by a low-power receiver. In one example, the signal is sent on PUCCH (e.g., PUCCH Format 0 or PUCCH Format 1). In one example, the signal is a PRACH, for example using a preconfigured RO.

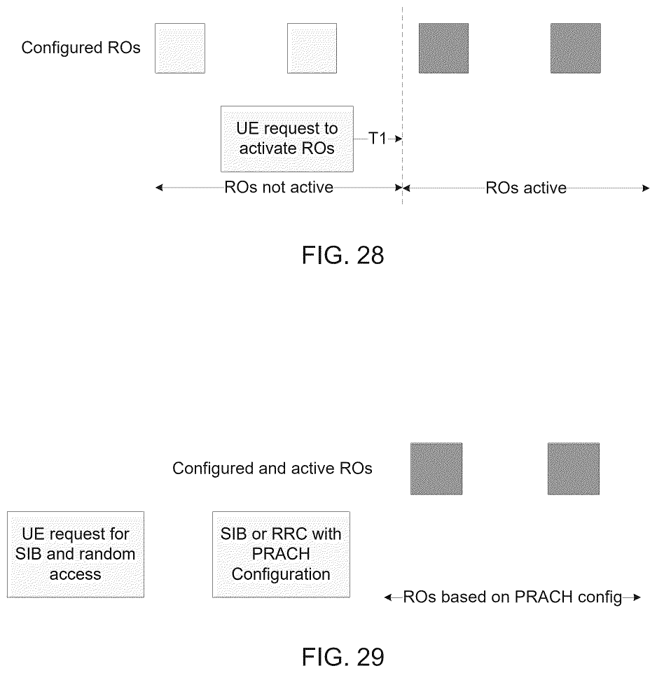

FIG. 28 illustrates an example of a channel/signal for requesting or activating a set of ROs according to embodiments of the present disclosure. For example, the channel/signal can be implemented by any of the UEs 111-116 of FIG. 1. These examples are for illustration only and other embodiments can be used without departing from the scope of the present disclosure.

In one example, a UE is configured a set of ROs for PRACH transmission. In one example, the UE receives configuration for a channel/signal to activate the ROs. In one example, the configuration is by SIB, e.g., SIB1 or SIBx or OD-SIB. In one example, the configuration is by RRC. In one example, as illustrated in FIG. 28, a UE transmits a channel/signal, as aforementioned, to request or activate the ROs. In one example, after a time T1 from the start or end or slot of the channel/signal that requests or activates the ROs, the UE can transmit in an RO from the set of configured ROs. In one example, after a time T1 from the start or end or slot of the channel/signal carrying the acknowledgment to the channel/signal requesting or activating the ROs, the UE can transmit in an RO from the set of configured ROs. In one example, starting from a time-unit that starts at or after a time T1 from the start or end or slot of the channel/signal that requests or activates the ROs, the UE can transmit in an RO from the set of configured ROs. In one example, starting from a time-unit that starts at or after a time T1 from the start or end or slot of the channel/signal carrying the acknowledgment to the channel/signal requesting or activating the ROs, the UE can transmit in an RO from the set of configured ROs. In one example, the channel/signal carrying the acknowledgement is a DCI Format. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.

In one example, a UE receives configuration for a channel/signal to trigger the transmission of (on-demand) system information, such as a specific system information block (SIB), and/or activate ROs for PRACH transmission on a first cell. The configuration can be received from a second cell or and can be preconfigured to the UE by the service provider. The configuration includes a first set of ROs or PRACH preambles and a second set of ROs or PRACH preambles. The first set of ROs or PRACH preambles is used by the UE to indicate a request for SIB transmission while also indicating that the UE does not intend to perform a random access on the cell in order to establish RRC connection on the cell, such as when the UE has no data to transmit, e.g., requesting OD-SIB in order to camp on the cell. In that manner, the network does not need to activate ROs, or receive PRACH in ROs, other than the ones associated with receptions of PRACHs serving to indicate a request for SIB transmission. For example, the network can maintain a long periodicity for the RO associated with the SIB request and a long periodicity for the SIB transmission without turning on other processing units associated with subsequent data communication with UEs. The second set of ROs or PRACH preambles is used by the UE to indicate both a request for SIB transmission for the UE to camp on the associated cell and that the UE intends to perform a random access on the cell in order to establish RRC connection on the cell or for SDT, such as when the UE has data to transmit or in case of mobility from a second cell to a first cell. In that manner, the network can provide ROs soon after the SIB transmission in order to reduce an initial access delay and begin to turn on other processing units associated with subsequent communication with the UE. The SIB can indicate a PRACH configuration for the UE to perform a random access procedure or the PRACH configuration for the random access procedure can be provided together with other parameters associated with the UE requesting SIB transmission on the cell. It is also possible that a PRACH transmission on a cell used to request SIB transmission on the cell is also used to perform initial access on the cell. A same partitioning of ROs or of PRACH preambles can also apply in that case for indicating only a request for SIB transmission without initiation of a subsequent random access procedure or for indicating both a request for SIB transmission and intention for a subsequent random access procedure.

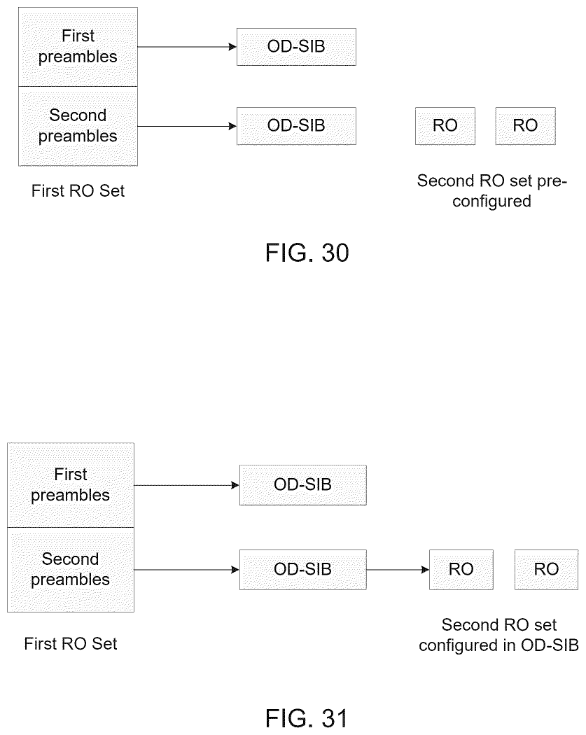

FIG. 29 illustrates an example of PRACH transmission in the ROs performed by the UE according to embodiments of the present disclosure. For example, the PRACH transmission can be implemented by any of the UEs 111-116 of FIG. 1. This example is for illustration only and other embodiments can be used without departing from the scope of the present disclosure.

As illustrated in FIG. 29, in one example, the UE transmits PRACH in the ROs, indicated by the PRACH configuration. In a variant example, the network indicates in the SIB or RRC message or in a separate message not to perform random access procedure. In one example, ROs configured and activated are associated with one SS/PBCH block. In one example, ROs configured and activated are associated with one SS/PBCH block, and the SS/PBCH block is indicated in the channel/signal from UE requesting SIB and random access. In one example, ROs configured and activated are associated with N SS/PBCH blocks. In one example, ROs configured and activated are associated with N SS/PBCH blocks, and the N SS/PBCH blocks are indicated in the channel/signal from UE requesting SIB and random access. In one example, ROs configured and activated are associated with N SS/PBCH blocks and the N SS/PBCH blocks are indicated in the SIB or RRC message with PRACH configuration or in a separate message.

In one example, the ROs activated can be the ROs associated with all SSBs or all CSI-RS. In one example, the PRACH ROs activated can be the ROs associated with one or more SSB or one or more CSI-RS, wherein the one or more SSBs or the one or more CSI-RS is determined based on the signal requesting or activating the ROs, e.g., based on explicit indication in the signal of the SSB(s) or CSI-RS(s), or based on implicit indication such as the timing or resources used for the signal.

In one example, the ROs remain active until a preamble is received. In one example, the ROs remain active until a preamble received from the UE transmitting the signal requesting or activating ROs. In one example, the ROs remain active for a time T2 from the start or end or slot of channel/signal requesting or activating ROs. In one example, ROs remain active for a time T2 from the time of activation of ROs. In one example, the UE can transmit a channel/signal to deactivate the ROs. In one example, the network receives multiple channels/signals from corresponding multiple UEs to request or activate ROs, the network activates the ROs until the network receives corresponding channels/signals from each of the corresponding UEs to deactivate ROs, and hence the ROs are deactivated.

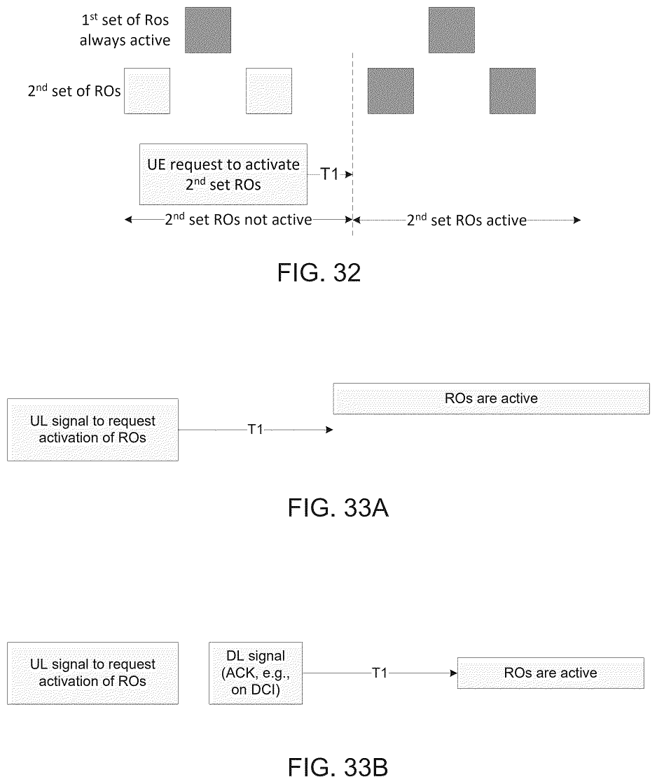

FIGS. 30-31 illustrate examples of a first and second set of ROs according to embodiments of the present disclosure. For example, the first and second set of ROs can be configured by BS 102 of FIG. 1. These examples are for illustration only and other embodiments can be used without departing from the scope of the present disclosure.

As illustrated in FIG. 30, in one example, a UE is configured with a first set ROs, and a second set ROs. Within the first set of ROs is a first set of preambles and a second set of preambles. The configuration can be received from a second cell or can be preconfigured to the UE by the service provider. The first set of preambles in a first set of ROs is used by the UE to indicate a request for SIB transmission (e.g., on-demand SIB (OD-SIB) while also indicating that the UE does not intend to perform a random access on the cell in order to establish RRC connection on the cell or for SDT, such as when the UE has no data to transmit, e.g., requesting OD-SIB in order to camp on the cell. As further illustrated in FIG. 30, in response to receiving a preamble from the first set of preambles, in the first set of ROs, the network transmits (on-demand) SIB. The second set of preambles of the first set ROs is used by the UE to indicate both a request for SIB transmission for the UE to camp on the associated cell and that the UE intends to perform a random access on the cell in order to establish RRC connection on the cell, such as when the UE has data to transmit or in case of mobility from a second cell to a first cell. As further illustrated in FIG. 30, in response to receiving a preamble from the second set of preambles, in the first set of ROs, the network transmits (on-demand) SIB, and activates second set of ROs. The UE can use the second set of ROs for random access procedure, this can include for initial access or for mobility or for SDT.

As illustrated in FIG. 31, in one example, a UE is configured with a first set ROs. Within the first set of ROs is a first set of preambles and a second set of preambles. The configuration can be received from a second cell or can be preconfigured to the UE by the service provider. The first set of preambles in a first set of ROs is used by the UE to indicate a request for SIB transmission while also indicating that the UE does not intend to perform a random access on the cell in order to establish RRC connection on the cell or for SDT, such as when the UE has no data to transmit, e.g., requesting OD-SIB in order to camp on the cell. As further illustrated in FIG. 31, in response to receiving a preamble from the first set of preambles, in the first set of ROs, the network transmits (on-demand) SIB. The second set preambles of the first set ROs is used by the UE to indicate both a request for SIB transmission for the UE to camp on the associated cell and that the UE intends to perform a random access on the cell in order to establish RRC connection on the cell, such as when the UE has data to transmit or in case of mobility from a second cell to a first cell. As further illustrated in FIG. 31, in response to receiving a preamble from the second set of preambles, in the first set of ROs, the network transmits (on-demand) SIB, the (on-demand) SIB can include a second PRACH configuration e.g., for a second set of ROs. The UE can use the second set of ROs for random access procedure, this can include for initial access or for mobility or for small data transmission (SDT).

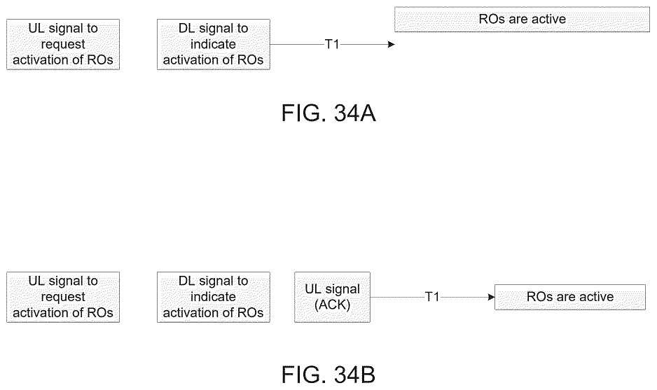

FIGS. 32-34B illustrate examples of a channel/signal for requesting or activating a set of ROs according to embodiments of the present disclosure. For example, the channel/signal can be implemented by any of the UEs 111-116 of FIG. 1. These examples are for illustration only and other embodiments can be used without departing from the scope of the present disclosure.

As illustrated in FIG. 32, in one example, a UE is configured a first set of ROs for RACH transmission and a second set of ROs for RACH transmission. In one example, the UE receives configuration for a channel/signal to activate the ROs of the second set. In one example, the configuration is by SIB, e.g., SIB1 or SIBx. In one example, the configuration is by RRC. In one example, the first set of ROs for PRACH transmission is active after configuration. As further illustrated in FIG. 32, in one example, a UE transmits a channel/signal, as aforementioned to request or activate the ROs of the second set. In one example, after a time T1 from the start or end or slot of the channel/signal that requests or activates the ROs of the second set, the UE can transmit in an RO from the second set of configured ROs. In one example, after a time T1 from the start or end or slot of the channel/signal carrying the acknowledgment to the channel/signal requesting or activating the ROs of the second set, the UE can transmit in an RO from the second set of configured ROs. In one example, starting from a time-unit that starts at or after a time T1 from the start or end or slot of the channel/signal that requests or activates the ROs of the second set, the UE can transmit in an RO from the second set of configured ROs. In one example, starting from a time-unit that starts at or after a time T1 from the start or end or slot of the channel/signal the acknowledgment to the channel/signal requesting or activating the ROs of the second set, the UE can transmit in an RO from the second set of configured ROs. In one example, the channel/signal carrying the acknowledgement is a DCI Format. In one example, the channel/signal carrying the acknowledgement is a sequence-based signal. In one example, a time-unit is a slot. In one example, a time-unit is symbol. In one example, a time-unit is a sub-frame. In one example, a time-unit is a frame. In one example, a time-unit is a PRACH configuration period. In one example, a time-unit is an association period. In one example, a time-unit is an association pattern period.

In one example, the ROs activated in the second set can be the ROs associated with all SSBs or all CSI-RS. In one example, the PRACH ROs activated in the second set can be the ROs associated with one or more SSB or one or more CSI-RS, wherein the one or more SSBs or the one or more CSI-RS is determined based on the signal requesting or activating the ROs of the second set, e.g., based on explicit indication in the signal of the SSB(s) or CSI-RS(s), for example the signal includes a list or a bitmap of SSBs or CSI-RSs, the ROs and/or preambles corresponding to these SSBs or CSI-RSs are activated/request to be activated, for example for a bit in the bitmap with value “1”, the corresponding SSB or CSI-RS is determined, and the corresponding/associated ROs and/or preambles are activated/requested to be activated. Or based on implicit indication such as the timing or resources used for the signal, for example based on a configured mapping between the timing or resource of requesting/activation signal and one or more SSBs or CSI-RSs, the corresponding/associated ROs and/or preambles (to the SSBs or CSI-RSs) are activated/request to be activated.

In one example, the ROs of the second set remain active until a preamble is received. In one example, the ROs of the second set remain active until a preamble received from the UE transmitting the signal requesting or activating ROs. In one example, the ROs of the second set remain active for a time T2 from the start or end or slot of channel/signal requesting or activating ROs of the second set. In one example, ROs remain active for a time T2 from the time of activation of ROs of the second set. In one example, the UE can transmit a channel/signal to deactivate the ROs of the second set. In one example, the network receives multiple channels/signals from corresponding multiple UEs to request or activate ROs of the second set, the network activates the ROs of the second set until the network receives corresponding channels/signals from each of the corresponding UEs to deactivate ROs of the second set, and hence the ROs of the second set are deactivated.

In a variant of the aforementioned examples, there are multiple second sets of ROs configured. One of the multiple second sets of ROs can be requested or activated by a UE. In one example, a set of the second sets is activated based on explicit indication in the signal activating or requesting ROs, e.g., based on signaling of an ID of one of the second sets. In one example, a set of the second sets is activated based on implicit indication in the signal activating or requesting ROs, e.g., based on the timing or resources used for the signal activating or requesting ROs, for example based on a configured mapping between the timing or resource of activation signal and an ID of a second set.

In a variant of the aforementioned examples, the first set of ROs is a subset of the second set of ROs. In a variant of the aforementioned examples, the second set of ROs is a superset of the first set of ROs.

In one example, a UE can transmit a first signal to request or activate ROs. In one example, the first signal is a wake-up-signal (WUS), e.g., sequence-based signal or PRACH preamble. In one example, the first signal is a low-power WUS (LP-WUS), wherein a LP-WUS can be based on on-off keying for transmission of a sequence and is received by a low-power receiver. In one example, the first signal is transmitted on PUCCH (e.g., PUCCH Format 0 or PUCCH Format 1). In one example, the first signal is transmitted on PUCCH Format 0, and PUCCH Format 0 is a low-power signal, e.g., can be based on on-off keying for transmission of a sequence and is received by a low-power receiver. As illustrated in FIG. 33A, in one example, in response to the first signal the network activates a PRACH configuration relative to the first signal. As illustrated in FIG. 33B, in one example, the network transmits a second signal in response to the first signal (e.g., the second signal includes acknowledgment to first signal, e.g., second signal uses DCI Format). In one example, the PRACH configuration is relative to second signal. In one example, the PRACH configuration starts at frame boundary. In one example, the PRACH configuration starts at frame SFN % N=0. In one example, N is the PRACH configuration period. In one example, N is the association period. In one example, N is the association pattern period.

In one example, a UE can transmit a signal to request or activate ROs. In one example, the signal is a wake-up-signal (WUS), e.g., sequence-based signal or RACH preamble. In one example, the signal is a low-power WUS (LP-WUS), wherein a LP-WUS can be based on on-off keying for transmission of a sequence and is received by a low-power receiver. In one example, the signal is transmitted on PUCCH (e.g., PUCCH Format 0 or PUCCH Format 1). In one example, the first signal is transmitted on PUCCH Format 0, and PUCCH Format 0 is a low-power signal, e.g., can be based on on-off keying for transmission of a sequence and is received by a low-power receiver. As illustrated in FIGS. 34A and 33B, in response to the signal from the UE, the network transmits a DL signal to indicate activation of ROs. In one example, the DL signal is SIB or RRC or MAC CE or L1 control (e.g., DCI Format or sequence-based signal). In one example, the DL signal is a channel/signal that triggers PRACH transmission (e.g., PDCCH order or sequence-based signal). In one example, ROs are activated after a time T1 from the start or end or slot of the DL channel/signal indicating activation of ROs as aforementioned. In one example, ROs are activated after or starting at a time-unit that starts at or after a time T1 from the start or end or slot of the DL channel/signal indicating activation of ROs as aforementioned. In one example, ROs are activated after a time T1 from the start or end or slot of the UL channel/signal carrying the acknowledgment of the DL signal indicating activation of ROs as aforementioned. In one example, ROs are activated after or starting at a time-unit that starts at or after a time T1 from the start or end or slot of the UL channel/signal carrying the acknowledgment of the DL signal indicating activation of ROs as aforementioned. The aforementioned examples, for activating a set of ROs based on a PDCCH order triggering or based on a DL signal indicating the activation of ROs apply.

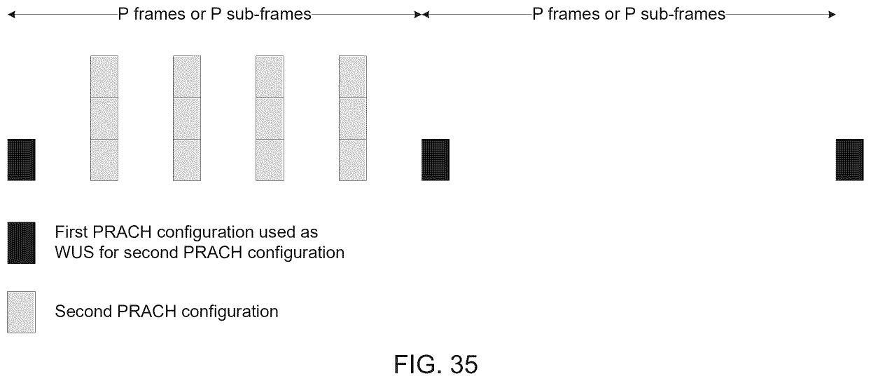

FIG. 35 illustrates an example of a first and second PRACH configuration according to embodiments of the present disclosure. For example, the PRACH configurations can be implemented by any of the UEs 111-116 of FIG. 1. This example is for illustration only and other embodiments can be used without departing from the scope of the present disclosure.

As illustrated in FIG. 35, in one example, the UE receives a first PRACH configuration for a first set of ROs, with a periodicity P frames or P subframes. The UE receives second PRACH configuration(s), wherein the second PRACH configuration(s) can have a second set of ROs (e.g., denser ROs). In one example, the first set of ROs are distinct from the second set of ROs. In one example, the first set of ROs and the second set of ROs can partially overlap in one or more ROs. In one example, for the first PRACH configuration every P frames or every P subframes a first RO or a set of first ROs (TDMed and/or FDMed) can occur. As illustrated in FIG. 35, the first ROs are used for a transmission of PRACH preamble which can be used as a WUS for activation of the second PRACH configuration. In one example, the gNB can detect the presence of a preamble (e.g., based on energy detection) in the first ROs to activate a corresponding second PRACH configuration. In one example, a UE can be configured a mapping between a preamble and/or RO (e.g., of the TDMed or FDMed ROs) and a corresponding second PRACH configuration. In one example, in response to the preamble transmitted in the first PRACH configuration (e.g. acting as a WUS), the network activates a corresponding second PRACH configuration as described herein. In one example, the activation of the second PRACH configuration is until the next occurrence of the first PRACH configuration (e.g., for P frames or P sub-frames). In one example, the activation of the second PRACH configuration is for a time Td. In one example, the activation of the second PRACH configuration is until the second PRACH configuration is deactivated.

In one example, the first PRACH configuration is configured with an offset O relative to SFN 0 or relative to sub-frame 0 of SFN 0. In one example, P is a divisor of 4096 frames, or 40960 sub-frames. In one example, P is a divisor of 1024 frames, or 10240 sub-frames. In one example, a mask is applied over the occasions of first PRACH configuration, wherein the mask is N bits, each bit of the N bits corresponds to an occasion of the N occasions. In one example, if the bit is “1” the corresponding occasion is monitored by the gNB, and if the bit is “0” the corresponding occasion is not monitored by the gNB (e.g. DRX at gNB), and the UE is not expected to transmit PRACH. In one example, if the bit is “0” the corresponding occasion is monitored by the gNB, and if the bit is “1” the corresponding occasion is not monitored by the gNB (e.g. DRX at gNB), and the UE is not expected to transmit PRACH. In example, N=X/P. In one example, X=1024 frames. In one example, X=10240 sub-frames. In one example, X=4096 frames. In one example, X=40960 sub-frames.

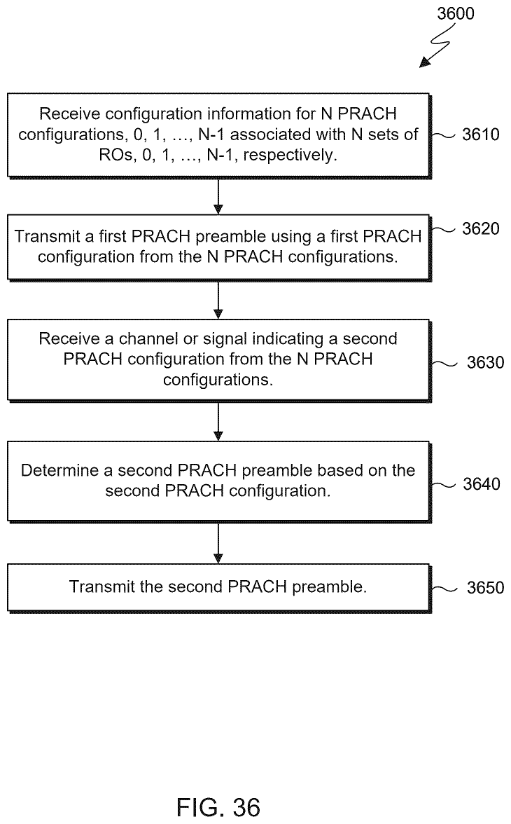

FIG. 36 illustrates an example method 3600 performed by a UE in a wireless communication system according to embodiments of the present disclosure. The method 3600 of can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3600 is for illustration only and other embodiments can be used without departing from the scope of the present disclosure.

The method begins with the UE receiving configuration information for N PRACH configurations, 0, 1, . . . , N−1 associated with N sets of ROs, 0, 1, . . . , N−1, respectively (3610). In various embodiments, the N PRACH configurations correspond to ROs associated with N sets of SS/PBCH blocks or CSI-RSs, respectively.

The UE then transmits a first PRACH preamble using a first PRACH configuration from the N PRACH configurations (3620). The UE then receives a channel or signal indicating a second PRACH configuration from the N PRACH configurations (3630). In various embodiments, N=2, the first PRACH configuration is received in SIB1, the first PRACH preamble triggers an OD-SIB, and the second PRACH configuration is received in the OD-SIB. In various embodiments, the channel or signal is a PDCCH order triggering the transmission of the second PRACH preamble. In various embodiments, the channel or signal is a sequence-based signal. The UE then determines a second PRACH preamble based on the second PRACH configuration (3640).

The UE then transmits the second PRACH preamble (3650). In various embodiments, the first PRACH configuration is associated with N sets of preambles, 0, 1, . . . , N−1, respectively. The UE determines a preferred PRACH configuration from the N PRACH configurations and transmits a preamble from a set of preambles of the N sets of preambles that is associated with the preferred PRACH configuration. In various embodiments, the UE receives configuration information for a time value. The second PRACH preamble is transmitted at or after the time value from the channel or signal.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive configuration information for N physical random access channel (PRACH) configurations, 0, 1, . . . , N−1 associated with N sets of PRACH occasions (ROs), 0, 1, . . . , N−1, respectively,
transmit a first PRACH preamble using a first PRACH configuration from the N PRACH configurations, and
receive a channel or signal indicating a second PRACH configuration from the N PRACH configurations; and
a processor operably coupled to the transceiver, the processor is configured to determine a second PRACH preamble based on the second PRACH configuration,
wherein the transceiver is further configured to transmit the second PRACH preamble.

2. The UE of claim 1, wherein:
the first PRACH configuration is associated with N sets of preambles, 0, 1, . . . , N−1, respectively,
the processor is further configured to determine a preferred PRACH configuration from the N PRACH configurations, and
the transceiver is further configured to transmit a preamble from a set of preambles of the N sets of preambles that is associated with the preferred PRACH configuration.

3. The UE of claim 1, wherein:
N=2,
the first PRACH configuration is received in system information block one (SIB1),
the first PRACH preamble triggers an on-demand system information block (OD-SIB), and
the second PRACH configuration is received in the OD-SIB.

4. The UE of claim 1, wherein the channel or signal is a physical downlink control channel (PDCCH) order triggering the transmission of the second PRACH preamble.

5. The UE of claim 1, wherein the channel or signal is a sequence-based signal.

6. The UE of claim 1, wherein:
the transceiver is further configured to receive configuration information for a time value, and
the second PRACH preamble is transmitted at or after the time value from the channel or signal.

7. The UE of claim 1, wherein the N PRACH configurations correspond to ROs associated with N sets of synchronization signal/physical broadcast channel (SS/PBCH) blocks or channel state information reference signals (CSI-RSs), respectively.

8. A base station (BS) comprising:
a transceiver configured to:
transmit configuration information for N physical random access channel (PRACH) configurations, 0, 1, . . . , N−1, associated with N sets of PRACH occasions (ROs), 0, 1, . . . , N−1, respectively, and
receive a first PRACH preamble using a first PRACH configuration from the N PRACH configurations; and
a processor operably coupled to the transceiver, the processor is configured to determine a second PRACH configuration from the N PRACH configurations,
wherein the transceiver is further configured to:
transmit a channel or signal indicating a second PRACH configuration, and
receive a second PRACH preamble based on the second PRACH configuration.

9. The BS of claim 8, wherein:
the first PRACH configuration is associated with N sets of preambles, 0, 1, . . . , N−1, respectively,
the first PRACH preamble is from a set of the N sets of preambles, and
the processor is further configured to determine the second PRACH configuration based on the transmitted preamble.

10. The BS of claim 8, wherein:
N=2,
the first PRACH configuration is transmitted in system information block one (SIB1),
the first PRACH preamble triggers an on-demand system information block (OD-SIB), and
the second PRACH configuration is transmitted in the OD-SIB.

11. The BS of claim 8, wherein the channel or signal is a physical downlink control channel (PDCCH) order triggering the transmission of the second PRACH preamble.

12. The BS of claim 8, wherein the channel or signal is a sequence-based signal.

13. The BS of claim 8, wherein:
the transceiver is further configured to transmit configuration information for a time value, and
the second PRACH preamble is received at or after the time value from the channel or signal.

14. The BS of claim 8, wherein the N PRACH configurations correspond to RO associated with N sets of synchronization signal/physical broadcast channel (SS/PBCH) blocks or channel state information reference signals (CSI-RSs), respectively.

15. A method of operating a user equipment (UE), the method comprising:
receiving configuration information for N physical random access channel (PRACH) configurations, 0, 1, . . . , N−1 associated with N sets of PRACH occasions (ROs), 0, 1, . . . , N−1, respectively;
transmitting a first PRACH preamble using a first PRACH configuration from the N PRACH configurations;
receiving a channel or signal indicating a second PRACH configuration from the N PRACH configurations;
determining a second PRACH preamble based on the second PRACH configuration; and
transmitting the second PRACH preamble.

16. The method of claim 15, wherein:
the first PRACH configuration is associated with N sets of preambles, 0, 1, . . . , N−1, respectively, and
the method further comprising:
determining a preferred PRACH configuration from the N PRACH configurations; and
transmitting a preamble from a set of preambles of the N sets of preambles that is associated with the preferred PRACH configuration.

17. The method of claim 15, wherein:
N=2,
the first PRACH configuration is received in system information block one (SIB1),
the first PRACH preamble triggers an on-demand system information block (OD-SIB), and
the second PRACH configuration is received in the OD-SIB.

18. The method of claim 15, wherein the channel or signal is one of:
a physical downlink control channel (PDCCH) order triggering the transmission of the second PRACH preamble, and
a sequence-based signal.

19. The method of claim 15, further comprising:
receiving configuration information for a time value,
wherein the second PRACH preamble is transmitted at or after the time value from the channel or signal.

20. The method of claim 15, wherein the N PRACH configurations correspond to ROs associated with N sets of synchronization signal/physical broadcast channel (SS/PBCH) blocks or channel state information reference signals (CSI-RSs), respectively.
